(19) United States
(12) Patent Application Publication
(10) Pub. No.: US 2011/0145465 A1
(43) Pub. Date: Jun. 16, 2011

(54) SEMICONDUCTOR MEMORY CARD

(75) Inventor: Takashi OKADA, Kanagawa (JP)

(73) Assignee: KABUSHIKI KAISHA TOSHIBA, Tokyo (JP)

(21) Appl. No.: 12/958,750

(22) Filed: Dec. 2, 2010

(30) Foreign Application Priority Data
Dec. 14, 2009 (JP) 2009-282425
Jul. 1, 2010 (JP) 2010-151149
Jul. 1, 2010 (JP) 2010-151150
Jul. 1, 2010 (JP) 2010-151151

(51) Int. Cl. G06F 13/00

(52) U.S. Cl. 710/301

(57) ABSTRACT

According to one embodiment, a semiconductor memory card includes a first and a second pin group used for reading/writing data in a first and a second modes and an interference portion that prevents the semiconductor memory card from being inserted up to a normal position of a card insertion hole of a connector dedicated to the first mode. One of the first and the second pin group is arranged in a tip portion in an insertion direction and the other in a rearward position therefrom, each of which in a direction perpendicular to the insertion direction aligned adjacent to each other. The insertion direction into the connector is identical regardless of which mode the semiconductor memory card is used in.

### CROSS-REFERENCE TO RELATED APPLICATIONS

This application is based upon and claims the benefit of priority from the prior Japanese Patent Application No. 2009-282425, filed on Dec. 14, 2009, Japanese Patent Application No. 2010-151149, filed on Jul. 1, 2010, Japanese Patent Application No. 2010-151150, filed on Jul. 1, 2010, and Japanese Patent Application No. 2010-151151, filed on Jul. 1, 2010; the entire contents all of which are incorporated herein by reference.

### FIELD

Embodiments described herein relate generally to a semiconductor memory card.

### BACKGROUND

In recent years, a memory card using a semiconductor memory such as a NAND flash memory is also used for recording continuously shot static images or high-resolution dynamic picture images. In such uses, reading and writing a large amount of data in a short time, that is, a higher data transfer rate is demanded. As an example, realizing the data transfer rate of 300 MByte/sec is demanded.

The data transfer rate of a conventional SD™ memory card (hereinafter, referred to as an SD memory card) is at most 20 MByte/sec. Thus, in addition to a normal operation mode (normal mode), making the SD memory card usable also in operation mode (high-speed mode) capable of reading and writing information faster than in normal mode has been proposed.

If a semiconductor memory card should be made usable also in high-speed mode, pins for high-speed mode will be provided separately from pins for normal mode. Like two-row arrangement adopted by, for example, the MMC (Multi Media Card) standard, pins compatible with signals used for the high-speed mode is newly provided (see Japanese Patent Application Laid-Open No. 2005-84935).

Incidentally, some conventional connectors used for reading/writing data from/to a conventional semiconductor memory card (semiconductor memory card dedicated to the normal mode) have terminals other than terminals corresponding to pins specified by a semiconductor memory card standard provided thereon. In the case of, for example, a connector capable of reading/writing data from/to at least two kinds of semiconductor memory cards, in addition to terminals corresponding to pins and specified by some standard of semiconductor memory card, non-standard terminals will be provided. If a semiconductor memory card having pins for high-speed mode is inserted into such a connector having non-standard terminals, there is the possibility of a pin for high-speed mode being brought into contact with a non-standard pin on the connector side. Such unexpected contact of pins could cause malfunctions such as corruption of recorded data.

### BRIEF DESCRIPTION OF THE DRAWINGS

FIG. 1 is a diagram showing the configuration of an SD memory card as a semiconductor memory card according to a first embodiment;

FIG. 2 is a front view of a hybrid SD memory card according to the first embodiment;

FIG. 3 is a diagram exemplifying the hybrid SD memory card whose signal pin is made smaller compared with a power pin or a ground pin;

FIG. 4 is a top view of a normal SD memory card;

FIG. 5 is a bottom view of the normal SD memory card;

FIG. 6 is a front view of the normal SD memory card;

FIG. 7 is a diagram showing the shape of a connector used when data is read/written from/into the normal SD memory card;

FIG. 8 is a diagram showing a state in which the normal SD memory card whose orientations, both front and rear, up and down are correct is inserted into a card insertion hole up to a back end of the card insertion hole;

FIG. 9 is a diagram showing the state in which the normal SD memory card, which is oriented, back-to-front, is inserted halfway through the card insertion hole;

FIG. 10 is a diagram showing the state in which the normal SD memory card, which is oriented upside down, cannot be inserted into the card insertion hole;

FIG. 11 is a diagram showing the shape of a connector compatible with a high-speed mode capable of causing the hybrid SD memory card to operate in high-speed mode;

FIG. 12 is a diagram showing the state in which the hybrid SD memory card is inserted into the card insertion hole of the connector compatible with the high-speed mode;

FIG. 13 is a diagram showing the state in which the normal SD memory card is inserted into the high-speed mode compatible connector;

FIG. 14 is a diagram showing the configuration of the SD memory card as the semiconductor memory card according to a second embodiment;

FIG. 15 is a diagram showing a relationship between a section viewed from behind the hybrid SD memory card and the card insertion hole of a normal connector;

FIG. 16 is a diagram showing the shape of the high-speed mode compatible connector used for reading/writing data from/to the hybrid SD memory card;

FIG. 17 is a diagram showing the state in which the hybrid SD memory card is inserted into the card insertion hole of the high-speed mode compatible connector;

FIG. 18 is a diagram showing the state in which the normal SD memory card is inserted into the high-speed mode compatible connector;

FIG. 19 is a diagram showing the configuration of the SD memory card as the semiconductor memory card according to a third embodiment;

FIG. 20 is a front view of the hybrid SD memory card according to the third embodiment;

FIG. 21 is a diagram showing the state in which the hybrid SD memory card is inserted into the card insertion hole of the high-speed mode compatible connector;

FIG. 22 is a diagram showing the state in which the normal SD memory card is inserted into the card insertion hole of the high-speed mode compatible connector;

FIG. 23 is a diagram showing the configuration of the SD memory card as the semiconductor memory card according to a fourth embodiment;

FIG. 24 is a diagram showing the state in which the hybrid SD memory card is inserted into the card insertion hole of the high-speed mode compatible connector to read from/write into the hybrid SD memory card;

FIG. 25 is a diagram showing the state in which the normal SD memory card is inserted into the card insertion hole of the high-speed mode compatible connector;

FIG. 26 is a diagram showing the configuration of the SD memory card as the semiconductor memory card according to a fifth embodiment;

FIG. 27A is a diagram showing an appearance of the hybrid SD memory card with a tip side thereof in an eye direction;

FIG. 27B is a diagram showing the appearance of the hybrid SD memory card with a rear side thereof in the eye direction;

FIG. 28 is a diagram showing the shape of the high-speed mode compatible connector used for reading/writing data from/to the hybrid SD memory card;

FIG. 29 is a diagram showing the state in which the hybrid SD memory card is inserted into the card insertion hole of the high-speed mode compatible connector;

FIG. 30A is a diagram showing the state in which a rib of the hybrid SD memory card in a back-to-front state interferes with an opening of the card insertion hole of the high-speed mode compatible connector;

FIG. 30B is a diagram showing the state in which the rib of the hybrid SD memory card in a back-to-front and upside-down state interferes with the opening of the card insertion hole of the high-speed mode compatible connector;

FIG. 30C is a diagram showing the state in which the rib of the hybrid SD memory card in an upside-down state interferes with the opening of the card insertion hole of the high-speed mode compatible connector;

FIG. 31 is a diagram showing the state in which the normal SD memory card is inserted into the card insertion hole of the high-speed mode compatible connector;

FIG. 32 is a diagram showing the configuration of the SD memory card as the semiconductor memory card according to a sixth embodiment;

FIG. 33A is a diagram showing the appearance of the hybrid SD memory card with the tip side thereof in the eye direction;

FIG. 33B is a diagram showing the appearance of the hybrid SD memory card with the rear side thereof in the eye direction;

FIG. 34 is a diagram showing the shape of the high-speed mode compatible connector used for reading/writing data from/to the hybrid SD memory card;

FIG. 35 is a diagram showing the state in which the hybrid SD memory card is inserted into the card insertion hole of the high-speed mode compatible connector;

FIG. 36 is a diagram showing the state in which the rib of the hybrid SD memory card in a reversed state or a thick portion on the rear end side interferes with an opening edge of the card insertion hole;

FIG. 37 is a diagram showing the state in which the normal SD memory card is inserted into the card insertion hole of the high-speed mode compatible connector;

FIG. 38 is a diagram showing the configuration of the SD memory card as the semiconductor memory card according to a seventh embodiment;

FIG. 39 is a front view of the hybrid SD memory card according to the seventh embodiment;

FIG. 40 is a diagram exemplifying the hybrid SD memory card whose signal pin is made smaller compared with the power pin or the ground pin;

FIG. 41 is a diagram showing an opening shape of the connector (high-speed mode compatible connector) compatible with the high-speed mode to read from/write into the hybrid SD memory card;

FIG. 42 is a diagram showing the state in which the hybrid SD memory card is inserted into the card insertion hole from the rear end side;

FIG. 43 is a diagram showing the state in which the hybrid SD memory card is inserted into the card insertion hole from the tip side;

FIG. 44 is a diagram showing the configuration of the SD memory card as the semiconductor memory card according to an eighth embodiment;

FIG. 45 is a diagram exemplifying the hybrid SD memory card whose signal pin is made smaller compared with the power pin or the ground pin;

FIG. 46 is a diagram showing the opening shape of the high-speed mode compatible connector to read from/write into the hybrid SD memory card;

FIG. 47 is a diagram showing the state in which the hybrid SD memory card is inserted into the card insertion hole of the high-speed mode compatible connector from the tip side;

FIG. 48 is a diagram showing the state in which the hybrid SD memory card is inserted into the card insertion hole from the rear end side;

FIG. 49 is a diagram showing the configuration of the SD memory card as the semiconductor memory card according to a ninth embodiment;

FIG. 50 is a front view of a high-speed SD memory card according to the ninth embodiment;

FIG. 51 is a diagram showing the state in which the high-speed SD memory card is inserted into the card insertion hole of the high-speed mode compatible connector according to the fifth embodiment;

FIG. 52A is a diagram showing the relationship between the opening shape of the card insertion hole of the normal connector and a sectional shape of the high-speed SD memory card;

FIG. 52B is a diagram showing the relationship between the opening shape of the card insertion hole of the normal connector and the sectional shape of the high-speed SD memory card;

FIG. 52C is a diagram showing the relationship between the opening shape of the card insertion hole of the normal connector and the sectional shape of the high-speed SD memory card;

FIG. 52D is a diagram showing the relationship between the opening shape of the card insertion hole of the normal connector and the sectional shape of the high-speed SD memory card;

FIG. 53 is a diagram showing the configuration of the high-speed SD memory card as the semiconductor memory card according to a tenth embodiment;

FIG. 54 is a front view of the high-speed SD memory card according to the tenth embodiment;

FIG. 55 is a diagram showing the state in which the high-speed SD memory card is inserted into the card insertion hole of the high-speed mode compatible connector;

FIG. 56A is a diagram showing the relationship between the opening shape of the card insertion hole of the normal connector and the sectional shape of the high-speed SD memory card;

FIG. 56B is a diagram showing the relationship between the opening shape of the card insertion hole of the normal connector and the sectional shape of the high-speed SD memory card;

FIG. 56C is a diagram showing the relationship between the opening shape of the card insertion hole of the normal connector and the sectional shape of the high-speed SD memory card;

FIG. 56D is a diagram showing the relationship between the opening shape of the card insertion hole of the normal connector and the sectional shape of the high-speed SD memory card;

FIG. 57 is a diagram showing the configuration of the high-speed SD memory card as the semiconductor memory card according to an eleventh embodiment;

FIG. 58 is a front view of the high-speed SD memory card according to the eleventh embodiment;

FIG. 59 is a diagram showing the state in which the high-speed SD memory card is inserted into the card insertion hole of the high-speed mode compatible connector;

FIG. 60A is a diagram showing the relationship between the opening shape of the card insertion hole of the normal connector and the sectional shape of the high-speed SD memory card; and

FIG. 60B is a diagram showing the relationship between the opening shape of the card insertion hole of the normal connector and the sectional shape of the high-speed SD memory card.

### DETAILED DESCRIPTION

In general, according to one embodiment, a semiconductor memory card includes a substrate on which a semiconductor memory and a controller that controls the semiconductor memory are mounted and a case that accommodates the substrate, and capable of reading/writing data from/to the semiconductor memory in first mode and in second mode in which the data is transferred faster than in the first mode. The semiconductor memory card includes a first pin group used for causing the controller to read/write the data from/to the semiconductor memory in the first mode, a second pin group used for causing the controller to read/write the data from/to the semiconductor memory in the second mode, and an interference portion that interferes with an opening or an inner wall portion of a card insertion hole of a connector dedicated to the first mode to prevent the semiconductor memory card from being inserted up to a normal position of the card insertion hole of the connector dedicated to the first mode. One of the first pin group and the second pin group is arranged in a tip portion thereof in the insertion direction and the other in a rearward position from the tip portion in the insertion direction, each of which arranged in a direction perpendicular to the insertion direction and aligned in two rows and adjacent to each other. The insertion direction into the connector is identical when used in the first mode and when used in the second mode.

Exemplary embodiments of a semiconductor memory card will be explained below in detail with reference to the accompanying drawings. The present invention is not limited to the following embodiments.

### FIRST EMBODIMENT

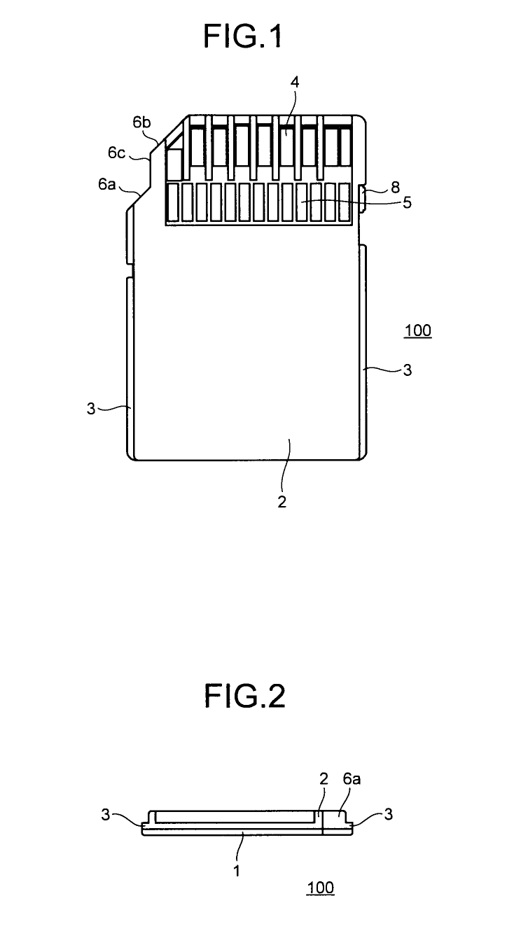

FIG. 1 is a diagram showing the configuration of an SD memory card as a semiconductor memory card according to a first embodiment. The SD memory card according to this embodiment is an SD memory card (hybrid SD memory card) capable of operating both in normal mode and in high-speed mode. Here, the upward direction on paper in FIG. 1 is an insertion direction into a connector and the upper side is defined as “front”. Similarly, the downward direction on paper in FIG. 1 is a removal direction from a connector and the lower side is defined as “rear”. Further, a depth direction from paper in FIG. 1 is defined as “up” and a forward direction from paper is defined as “down”. An SD memory card 100 is configured by accommodating a substrate (not shown) on which a memory package (not shown) formed of a nonvolatile semiconductor memory such as an NAND-type flash memory and a memory controller (not shown) that controls the memory package inside a case composed of an upper case 1 (not shown in FIG. 1) and a lower case 2.

FIG. 2 shows a front view of the hybrid SD memory card 100. As shown in FIG. 2, the hybrid SD memory card 100 has a rib 3 formed on both side surfaces and a front sight thereof presents a substantially convex form with the width a little narrower on the down side. This is just like, as described later, an SD memory card operating only in normal mode.

A plurality of normal mode pins 4 (corresponding to the first pin group) used when the hybrid SD memory card 100 is caused to operate in normal mode (when the memory controller is caused to read/write data from/to the memory package in normal mode) is arranged near the tip on a down surface of the hybrid SD memory card 100 arrayed in a direction crossing the insertion direction. Moreover, a plurality of high-speed mode pins 5 (corresponding to the second pin group) used when the hybrid SD memory card 100 is caused to operate in high-speed mode (when the memory controller is caused to read/write data from/to the memory package in high-speed mode) is arranged in the rear direction from the area where the normal mode pins 4 of the hybrid SD memory card 100 are arranged arrayed in a direction crossing the insertion direction. The normal mode pins 4 and the high-speed mode pins 5 are an electrode pattern formed on the above substrate (not shown) and exposed on the down surface side of the hybrid SD memory card 100 through an opening provided in the lower case 2. The high-speed mode pins 5 are pins for transmitting/receiving a differential signal and are arranged more in number than the normal mode pins 4. Here, a configuration example in which the number of the high-speed mode pins 5 is larger than that of the normal mode pins 4 is shown, but the number of the high-speed mode pins 5 does not always have to be larger than that of the normal mode pins 4. The number of the high-speed mode pins 5 can be made equal to or smaller than that of the normal mode pins 4 by using a clock pin for both the high-speed mode and the normal mode or reducing the power pins.

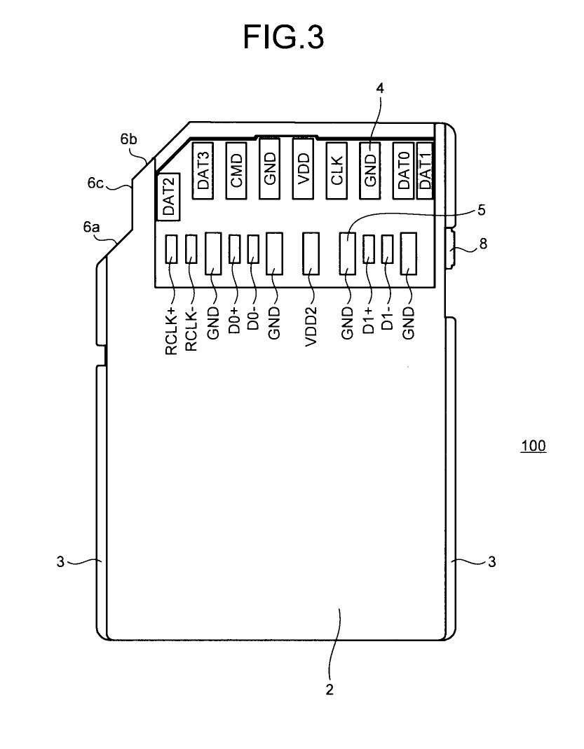

For example, differential clock signals RCLK+ and RCLK−, differential data signals D0+ and D0−, differential data signals D1+ and D1−, and power sources VDD2 and GND are assigned to the high-speed mode pins 5. By making the area of the signal pins (the differential clock signals RCLK±, differential data signals D0± and D1±) smaller than that of the power sources VDD2 and GND, realization of faster data transfer rate is made easier. FIG. 3 is a diagram exemplifying the hybrid SD memory card whose signal pin is made smaller compared with the power pin or the ground pin. Moreover, by arranging the normal mode power pin (VDD) and the high-speed mode power pin (VDD2) adjacent to each other (positions thereof in the width direction of the SD memory card are the same), the power terminal of a connector compatible with the high-speed mode will not come into contact with the normal mode signal pin or GND pin. Accordingly, an abnormal operation (such as an overcurrent and latchup) due to a reverse bias caused after the power terminal of the connector comes into contact with the signal pin or GND pin can be prevented. Further, pin arrangement is created in such a way that the distance between the power pin and GND pin increases so that a problem of an increasing leak current when the distance between the power pin and GND pin is very small can be avoided.

The hybrid SD memory card 100 is formed so that a step 6a and a step 6b in the width direction are linked to a side surface 6c on one side of the side surface thereof.

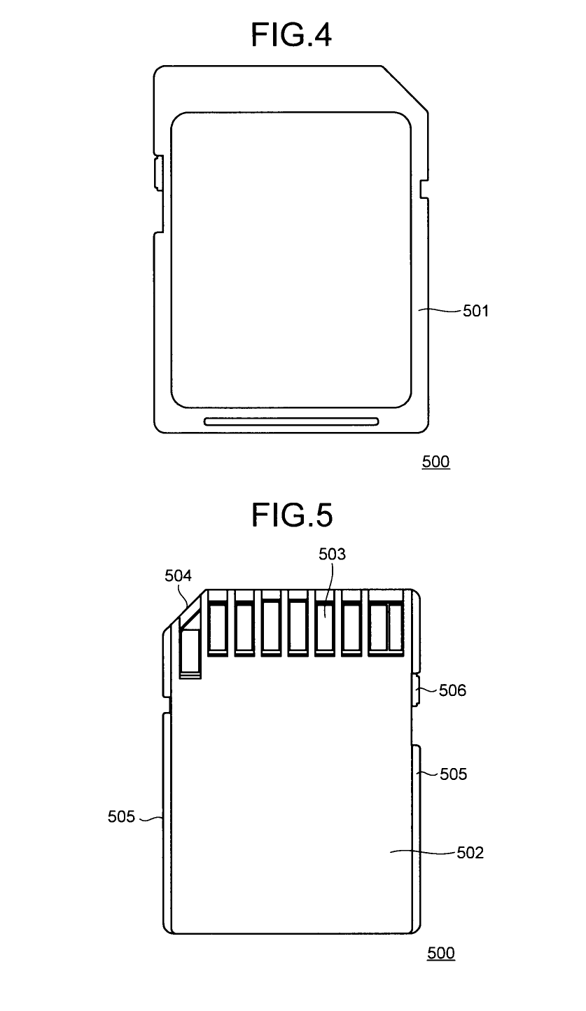

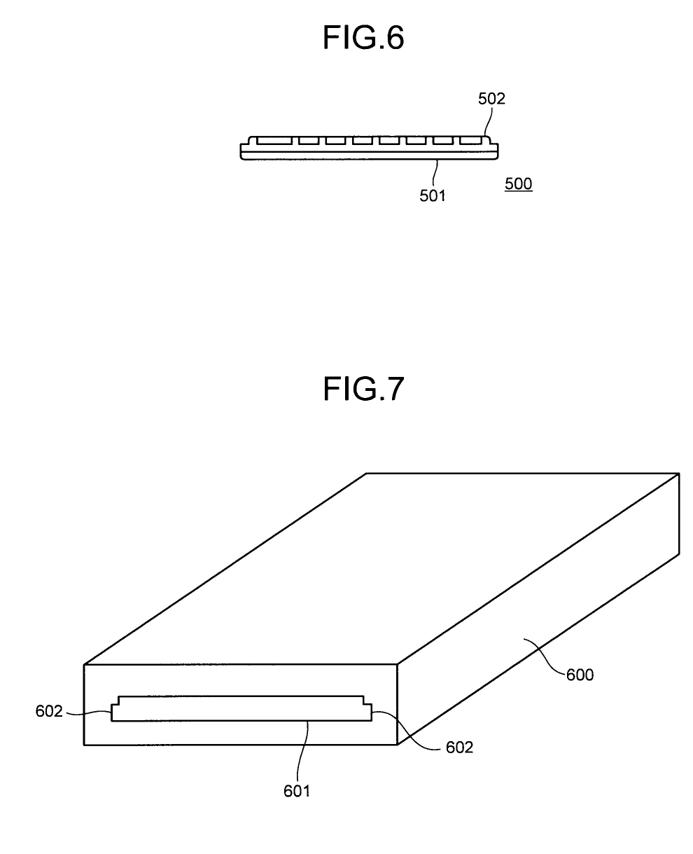

For the purpose of comparison, the configuration of an SD memory card operating only in normal mode (normal SD memory card) is shown in FIGS. 4 to 6. FIG. 4 is a top view of the normal SD memory card, FIG. 5 is a bottom view of the normal SD memory card, and FIG. 6 is a front view of the normal SD memory card. A normal SD memory card 500 is configured, like the hybrid SD memory card 100 according to this embodiment, by accommodating a substrate on which a memory package formed of a nonvolatile semiconductor memory such as an NAND-type flash memory and a memory controller that controls the memory package are mounted inside a case composed of an upper case 501 and a lower case 502. The normal SD memory card 500 has a plurality of pins 503 arranged near the tip on the down surface arrayed in a direction crossing the insertion direction. The normal SD memory card 500 also has a neck 504 provided with one side surface on the tip side slanted, tapering the normal SD memory card 500. The normal SD memory card 500 has a rib 505 provided on both side surfaces. Moreover, a write protect switch 506 is formed on the side surface on the side opposite to the side on which the neck 504 is formed. The normal SD memory card 500 is write-enabled when the write protect switch 506 is arranged on the tip side and write-disabled when the write protect switch 506 is arranged on a rear end side.

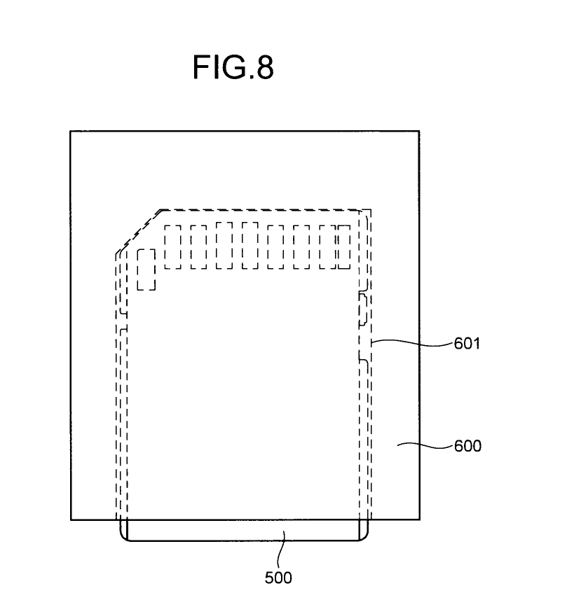

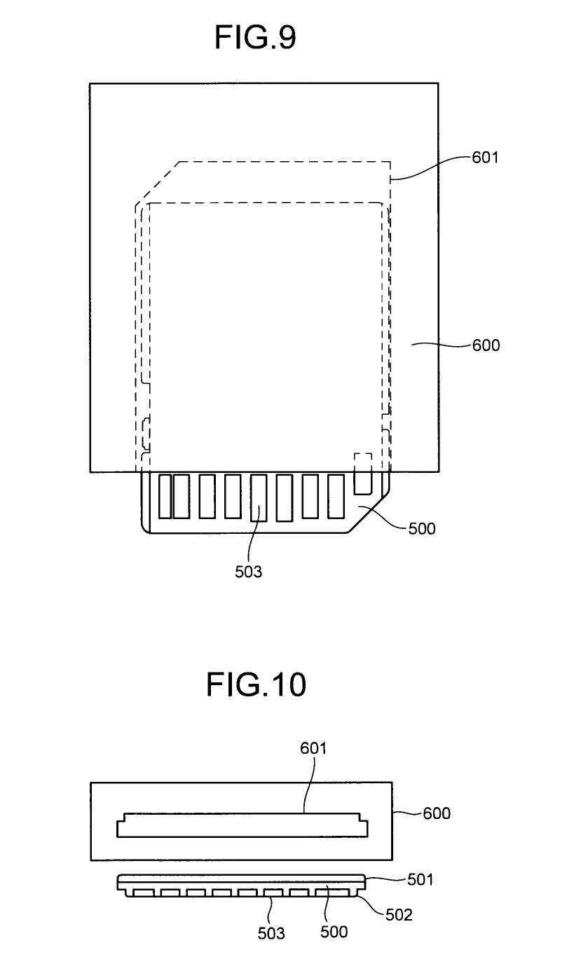

FIG. 7 is a diagram showing the shape of a connector (normal connector) used when data is read/written from/into the normal SD memory card 500. A card insertion hole 601 of a normal connector 600 has an opening shape corresponding to the shape in the front sight of the normal SD memory card 500 and has a groove 602 corresponding to the rib 505 formed on both inner walls. The card insertion hole 601 has a convex opening that is substantially the same shape as the front sight of the normal SD memory card 500. That is, the width of the card insertion hole 601 is a little wider than a wider portion of the width of the normal SD memory card 500. The width of the card insertion hole 601 has a size to the extent that the normal SD memory card 500 is fixed when the normal SD memory card 500 is inserted into the normal connector 600. Therefore, the normal SD memory card 500 can be inserted up to a back end of the card insertion hole 601 if the normal SD memory card 500 is correctly oriented, both front and rear, up and down. FIG. 8 is a diagram showing a state in which the normal SD memory card whose orientations, both front and rear, up and down are correct is inserted into the card insertion hole up to the rear end of the SD memory card. However, the card insertion hole 601 of the normal connector 600 is tapered matching the normal SD memory card 500. Thus, if the normal SD memory card 500 is oriented back-to-front, the normal SD memory card 500 can be inserted into the card insertion hole 601 up to some midpoint. FIG. 9 is a diagram showing the state in which the normal SD memory card, which is oriented back-to-front, is inserted halfway through the card insertion hole. If the normal SD memory card 500 is upside down, the normal SD memory card 500 cannot be inserted at all because of non-matching shape of the opening of the card insertion hole 601. FIG. 10 is a diagram showing the state in which the normal SD memory card, which is oriented upside down, cannot be inserted into the card insertion hole.

The width of the hybrid SD memory card 100 on the tip side from the step 6a is like the normal SD memory card 500. More specifically, this means that when the hybrid SD memory card 100 and the normal SD memory card 500 are piled up vertically by superposing tip portions on the side on which the normal mode pins 4 or the pins 503 are arranged, shapes thereof on the tip side from the step 6a are the same.

The width of the hybrid SD memory card 100 on the rear side from the step 6a (width of the widest portion) is wider than the width of the normal SD memory card 500 on the rear side from the neck 504 (width of the widest portion).

The hybrid SD memory card 100 has the rib 3 formed on both side surfaces. The hybrid SD memory card 100 also has a write protect switch 8 formed on the side opposite to the side on which the steps 6a and 6b are formed. The hybrid SD memory card 100 is write-enabled when the write protect switch 8 is arranged on the tip side and write-disabled when the write protect switch 8 is arranged on the rear end side.

The width of the hybrid SD memory card 100 according to this embodiment on the tip side is the same as that of the normal SD memory card 500. Thus, if correctly oriented, both front and rear, up and down, the tip portion of the hybrid SD memory card 100 can be inserted into the card insertion hole 601 of the normal connector 600. However, a portion of the step 6a of the hybrid SD memory card 100 bumps into and interferes with an edge of the card insertion hole 601 of the normal connector 600 so that the hybrid SD memory card 100 can be inserted up to this point.

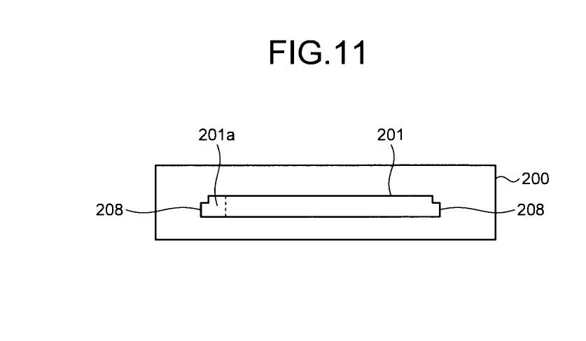

FIG. 11 is a diagram showing the shape of a connector (high-speed mode compatible connector) 200 compatible with the high-speed mode capable of causing the hybrid SD memory card 100 to operate in high-speed mode. A card insertion hole 201 of the high-speed mode compatible connector 200 has an opening shape corresponding to the shape in the front sight of the hybrid SD memory card 100 and has a groove 208 corresponding to the ribs 3, 505 formed on both inner walls. The shape of the card insertion hole 201 of the high-speed mode compatible connector 200 corresponds to the shape of the hybrid SD memory card 100 in the width direction and a step 201a is formed on one inner wall, which makes the width of the card insertion hole 201 narrower at some midpoint.

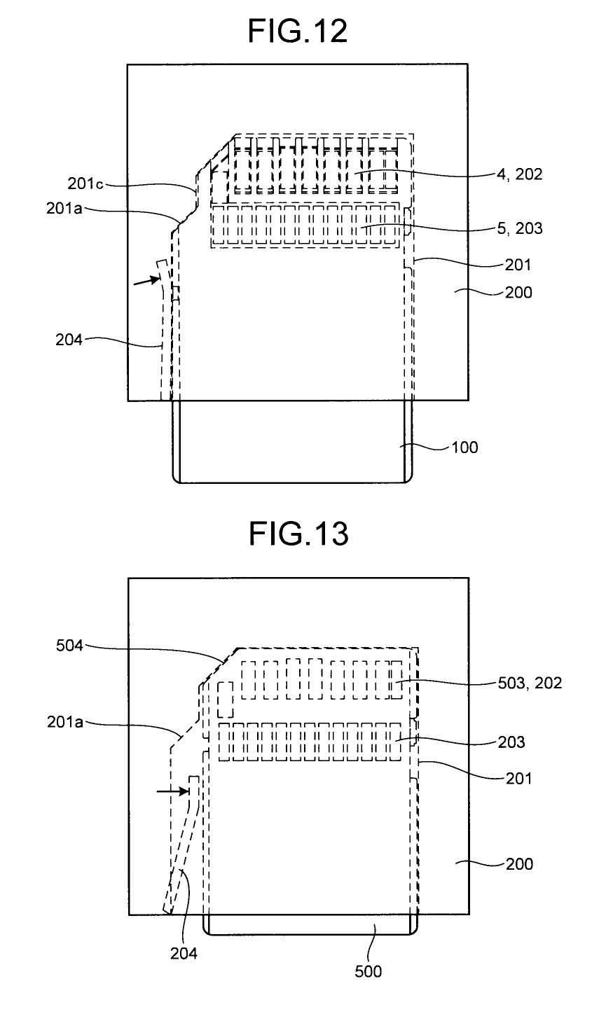

FIG. 12 is a diagram showing the state in which the hybrid SD memory card 100 is inserted into the card insertion hole 201 of the connector (high-speed mode compatible connector) 200 compatible with the high-speed mode. The shape of the card insertion hole 201 of the high-speed mode compatible connector 200 corresponds to the shape of the hybrid SD memory card 100 in the width direction and a step 201a is formed on one inner wall, which makes the width of the card insertion hole 201 narrower at some midpoint. Thus, the hybrid SD memory card 100 fits into the card insertion hole 201 of the high-speed mode compatible connector 200 with almost no gap. If the hybrid SD memory card 100 fits into the card insertion hole 201, the normal mode pins 4 are arranged at a position corresponding to normal mode terminals 202 arranged near the back end of the card insertion hole 201 and the high-speed mode pins 5 are arranged at a position corresponding to high-speed mode terminals 203 arranged on the opening side from a portion the width of the card insertion hole 201 decreases.

FIG. 13 is a diagram showing the state in which the normal SD memory card 500 is inserted into the high-speed mode compatible connector 200. Since the width near the opening of the card insertion hole 201 of the high-speed mode compatible connector 200 is wider than the normal SD memory card 500, a gap arises between the inserted normal SD memory card 500 and the inner wall of the card insertion hole 201. However, the normal SD memory card 500 is energized by an energizing member 204 set up in the high-speed mode compatible connector 200 through the side surface having the neck 504 and the side surface that does not have the neck 504 is pressed against the inner wall of the card insertion hole 201. Accordingly, the normal SD memory card 500 is inserted up to the back end of the card insertion hole 201 without coming into contact with the step 201a of the card insertion hole 201. Thus, the pins 503 formed near the tip of the normal SD memory card 500 are arranged at a position corresponding to the normal mode terminals 202 arranged near the back end of the card insertion hole 201 of the high-speed mode compatible connector 200. Therefore, the normal SD memory card 500 can be inserted into the card insertion hole 201 of the high-speed mode compatible connector 200 to read or write data. Moreover, the normal SD memory card 500 has no pin provided in an area corresponding to an area where the high-speed mode terminals 203 are arranged and thus, even if the normal SD memory card 500 is inserted, there is not possibility that the normal SD memory card 500 comes into contact with the high-speed mode terminals 203 of the high-speed mode compatible connector 200.

When the hybrid SD memory card 100 compatible with the high-speed mode is inserted into the high-speed mode compatible connector 200, the high-speed mode compatible connector 200 may bring only the high-speed mode pins 5 into contact with the high-speed mode terminals 203 so that the normal mode terminals 202 and the normal mode pins 4 are not brought into contact. This is a case when, for example, the normal mode terminals 202 are not arranged in the high-speed mode compatible connector 200 or only a part of the normal mode terminals 202 is arranged. Similarly, when the normal SD memory card 500 is inserted, the high-speed mode compatible connector 200 may bring only the pins 503 into contact with the normal mode terminals 202 so that the high-speed mode terminals 203 do not come into contact with the lower case 502 of the normal SD memory card 500. Whether an inserted SD memory card is a card compatible with the high-speed mode can be detected based on, for example, the amount of deformation of the energizing member 204. However, the method thereof is not limited to this and other publicly known methods (such as an optical method, magnetic method, electric method, and mechanical method) may also be used for detection.

If an attempt is made to insert the hybrid SD memory card 100 compatible with the high-speed mode into the normal connector 600, the step 6a is caught by an opening edge of the card insertion hole 601 because the width of the hybrid SD memory card 100 is wider than the width on the rear side from the neck 504 of the normal SD memory card 500 (width of the widest portion). Therefore, the hybrid SD memory card 100 cannot be inserted into the normal connector 600. Thus, only a tip portion of the hybrid SD memory card 100 according to this embodiment can be inserted into the normal connector 600 so that malfunctions such as corruption of recorded data after the high-speed mode pin 5 being brought into contact with a terminal of the normal connector 600 dedicated to the normal mode will not occur. Not only the hybrid SD memory card 100, but also the normal SD memory card 500 can be inserted into the high-speed mode compatible connector 200 and therefore, the pins 503 of the normal SD memory card 500 can be brought into contact with the normal mode pins 4.

### SECOND EMBODIMENT

FIG. 14 is a diagram showing the configuration of an SD memory card as a semiconductor memory card according to a second embodiment. The SD memory card is configured, like the first embodiment, by accommodating a substrate on which a memory package formed of a nonvolatile semiconductor memory such as an NAND-type flash memory and a memory controller that controls the memory package are mounted inside a case and thus, only differences from the first embodiment will be described.

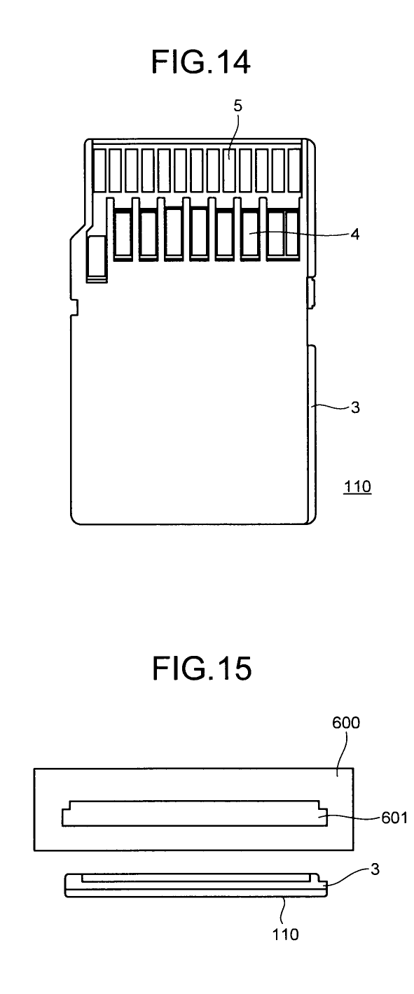

The width on the rear end side of a hybrid SD memory card 110 is the same as that of the normal SD memory card 500. In other words, in contrast to the hybrid SD memory card 100, the hybrid SD memory card 110 has no step formed on the side surface and a wider portion in width of the normal SD memory card 500 is almost the same as a wider portion in width of the hybrid SD memory card 110. Moreover, the hybrid SD memory card 110 has the rib 3 formed only on one side of the side surface. FIG. 15 is a diagram showing a relationship between a section viewed from behind the hybrid SD memory card 110 and the card insertion hole 601 of the normal connector 600. As shown in FIG. 15, the width of the card insertion hole 601 and that of the hybrid SD memory card 110 when viewed from behind are almost the same. However, the hybrid SD memory card 110 has the rib 3 formed only on one side and thus, cannot be inserted into the card insertion hole 601 of the normal connector 600.

The hybrid SD memory card 110 according to this embodiment has a shape similar to that obtained by stretching the normal SD memory card 500 to the tip side from some midpoint of the neck 504 and an area where the normal mode pins 4 are arranged is not near the tip. The plurality of high-speed mode pins 5 is arranged in an area stretched from some midpoint of the neck in a direction crossing the insertion direction. That is, in this embodiment, the plurality of high-speed mode pins 5 used when the hybrid SD memory card 110 is caused to operate in high-speed mode is arranged near the tip on the down surface of the hybrid SD memory card 110 arrayed in a direction crossing the insertion direction. Also, the plurality of normal mode pins 4 used when the hybrid SD memory card 110 is caused to operate in normal mode is arranged in the rearward position from the area where the hybrid SD memory card 110 is stretched arrayed in a direction crossing the insertion direction.

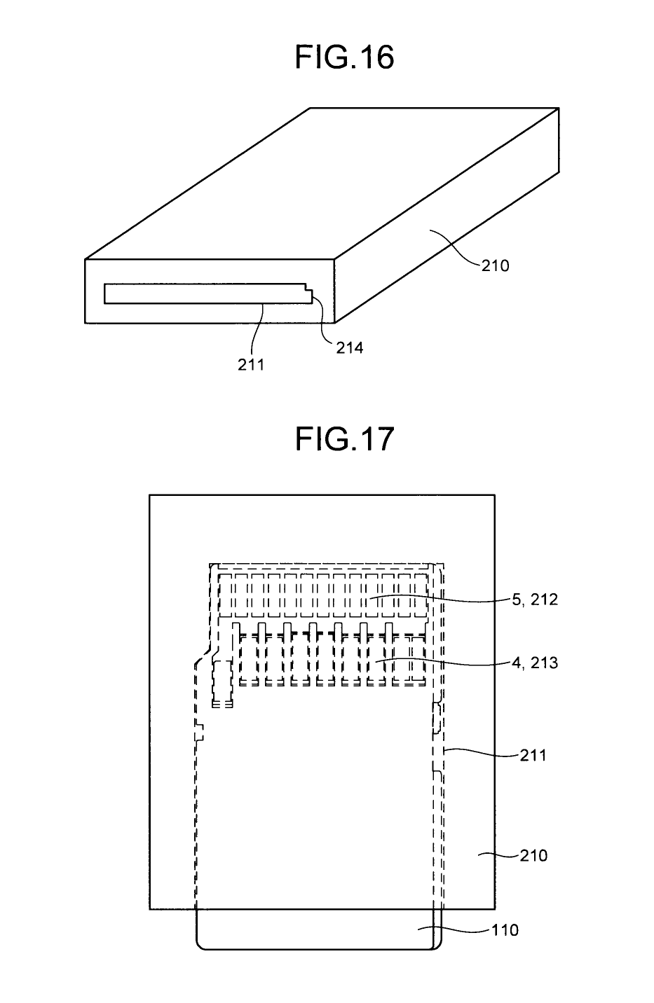

FIG. 16 is a diagram showing the shape of a high-speed mode compatible connector 210 used for reading/writing data from/to the hybrid SD memory card 110. A card insertion hole 211 of the high-speed mode compatible connector 210 has an opening shape corresponding to the shape in the front sight of the hybrid SD memory card 110 and has a groove 214 corresponding to the rib 3 formed on one inner wall. Thus, if correctly oriented, both front and rear, up and down, the rib 3 fits into the groove 214 of the card insertion hole 211 so that the hybrid SD memory card 110 can be inserted up to the back end of the card insertion hole 211.

FIG. 17 is a diagram showing the state in which the hybrid SD memory card 110 is inserted into the card insertion hole 211 of the high-speed mode compatible connector 210. By inserting the hybrid SD memory card 110 up to the back end of the card insertion hole 211, the high-speed mode pins 5 are arranged at a position corresponding to high-speed mode terminals 212 arranged near the back end of the card insertion hole 211. Also, by inserting the hybrid SD memory card 110 up to the back end of the card insertion hole 211, the normal mode pins 4 are arranged at a position corresponding to normal mode terminals 213 arranged on an opening side from the high-speed mode terminals 212.

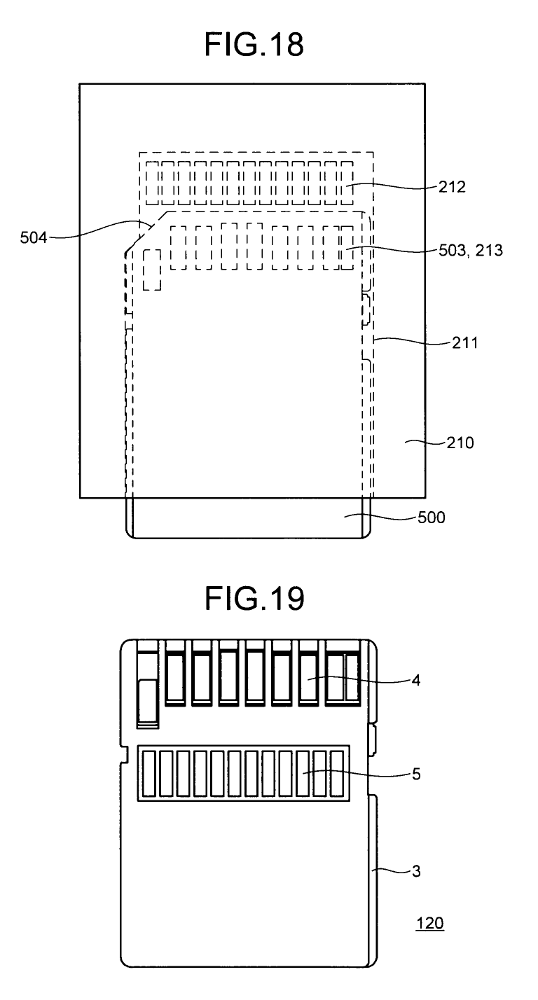

FIG. 18 is a diagram showing the state in which the normal SD memory card 500 is inserted into the high-speed mode compatible connector 210. The width of the card insertion hole 211 of the high-speed mode compatible connector 210 is almost the same as that of the normal SD memory card 500. Thus, the normal SD memory card 500 can be inserted only as far as the neck 504 bumps. Thus, the pins 503 formed near the tip of the normal SD memory card 500 are arranged at a position corresponding to normal mode terminals 213 arranged in an intermediate portion in the depth direction of the card insertion hole 211 of the high-speed mode compatible connector 210. Therefore, the normal SD memory card 500 can be inserted into the card insertion hole 211 of the high-speed mode compatible connector 210 to read or write data. Even if the normal SD memory card 500 is inserted into the card insertion hole 211, the card does not reach an area where the high-speed mode terminals 212 are arranged. Thus, there is not possibility that the high-speed mode terminals 212 of the high-speed mode compatible connector 210 erroneously come into contact with a pin of the normal SD memory card 500. Moreover, the high-speed mode terminals 212 do not even come into contact with the body of the normal SD memory card 500. As a result, the possibility that the outer shape of the normal SD memory card 500 is damaged by contact between the high-speed mode terminals 212 and the body of the normal SD memory card 500 can be reduced. Also, durability of the high-speed mode terminals 212 can be improved. Furthermore, when the normal SD memory card 500 is inserted into the high-speed mode compatible connector 210, friction of the high-speed mode terminals 212 can be avoided. As a result, the normal SD memory card 500 can easily be inserted into the high-speed mode compatible connector 210.

Thus, the hybrid SD memory card 110 according to this embodiment cannot be inserted into the normal connector 600 at all and thus, malfunctions such as corruption of stored data after the high-speed mode pin 5 is brought into contact with a pin of the normal connector 600 dedicated to the normal mode will not occur. Moreover, not only the hybrid SD memory card 110, but also the normal SD memory card 500 can be inserted into the high-speed mode compatible connector 210 and therefore, the pins 503 of the normal SD memory card 500 can be brought into contact with the normal mode pins 4.

### THIRD EMBODIMENT

FIG. 19 is a diagram showing the configuration of an SD memory card as a semiconductor memory card according to a third embodiment. The SD memory card is configured, like the first and the second embodiments, by accommodating a substrate on which a memory package formed of a nonvolatile semiconductor memory such as an NAND-type flash memory and a memory controller that controls the memory package are mounted inside a case and thus, only differences from the first and the second embodiments will be described.

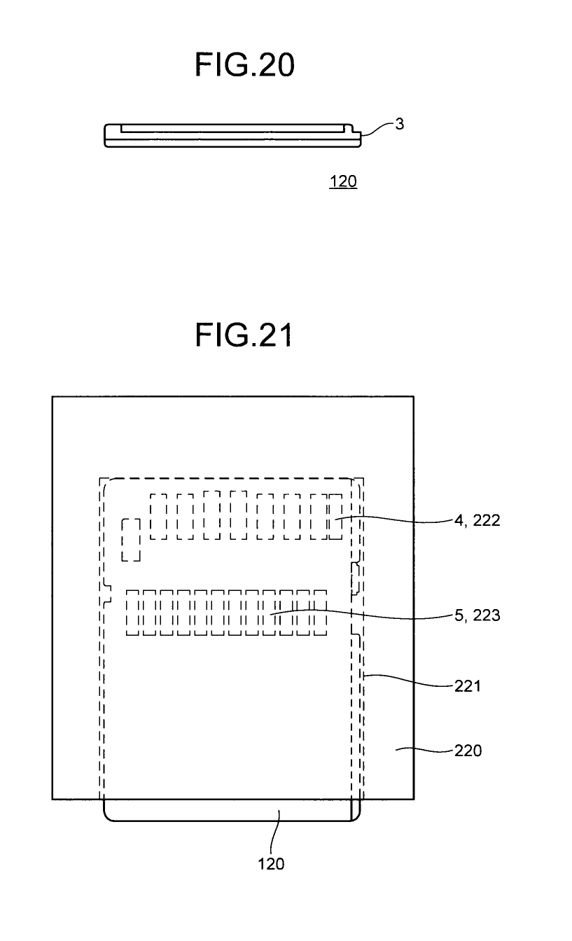

The width of a hybrid SD memory card 120 is the same as the width on the rear side from the neck 504 (the widest portion) of the normal SD memory card 500. The hybrid SD memory card 120 according to this embodiment has no neck. FIG. 20 is a front view of the hybrid SD memory card 120. As shown in FIG. 20, the hybrid SD memory card 120 has the rib 3 formed only on one side of the side surface and, like the second embodiment, cannot be inserted into the card insertion hole 601 of the normal connector 600.

The plurality of normal mode pins 4 used when the hybrid SD memory card 120 is caused to operate in normal mode is arranged near the tip on the down surface of the hybrid SD memory card 120 in a direction crossing the insertion direction. Also, the plurality of high-speed mode pins 5 used when the hybrid SD memory card 120 is caused to operate in high-speed mode is arranged in the rearward position from the area where the normal mode pins 4 of the hybrid SD memory card 120 are arranged in a direction crossing the insertion direction.

FIG. 21 is a diagram showing the state in which the hybrid SD memory card 120 is inserted into a card insertion hole 221 of a high-speed mode compatible connector 220. The opening shape of the card insertion hole 221 is similar to that in the second embodiment, includes a groove corresponding to the rib 3 on one inner wall, and the hybrid SD memory card 120 can be inserted only if the card is correctly oriented, both front and rear, up and down. By inserting the hybrid SD memory card 120 up to the back end of the card insertion hole 221, the normal mode pins 4 are arranged at a position corresponding to normal mode terminals 222 arranged near the back end of the card insertion hole 221 and the high-speed mode pins 5 are arranged at a position corresponding to high-speed mode terminals 223 arranged on the opening side from the normal mode terminals 222.

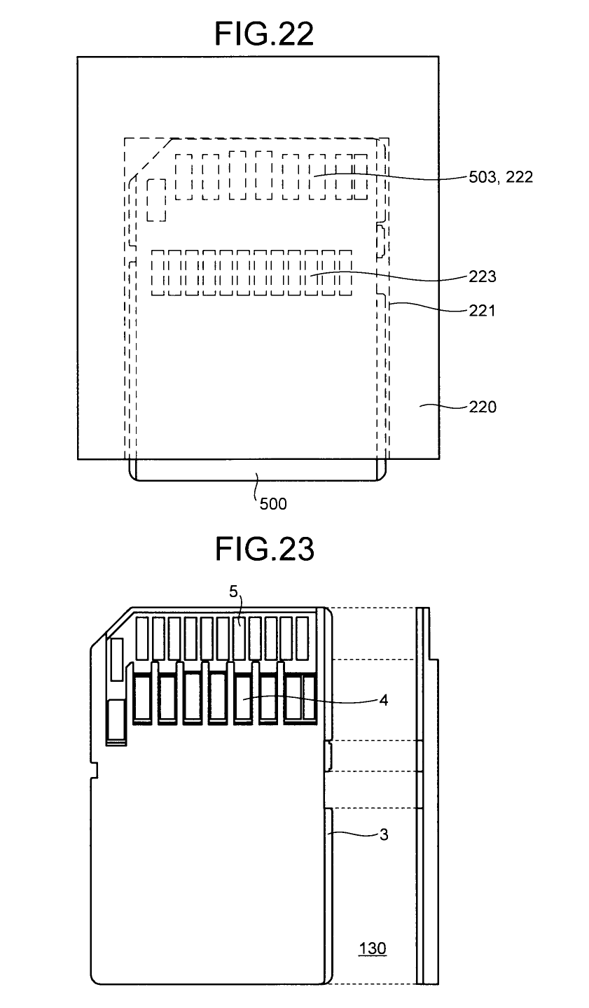

FIG. 22 is a diagram showing the state in which the normal SD memory card 500 is inserted into the card insertion hole 221 of the high-speed mode compatible connector 220. Just like when the hybrid SD memory card 120 is inserted, the normal SD memory card 500 is inserted up to the back end of the card insertion hole 221 and the pins 503 formed near the tip of the normal SD memory card 500 are arranged at a position corresponding to the normal mode terminals 222 arranged near the back end of the card insertion hole 221. Therefore, the normal SD memory card 500 can be inserted into the card insertion hole 221 of the high-speed mode compatible connector 220 to read or write data. Moreover, the normal SD memory card 500 has no pin provided in an area corresponding to an area where the high-speed mode terminals 223 are arranged and thus, there is not possibility that the normal SD memory card 500 erroneously comes into contact with the high-speed mode terminals 223 of the high-speed mode compatible connector 220.

Thus, the hybrid SD memory card 120 according to this embodiment cannot be inserted into the normal connector 600 at all and thus, malfunctions such as corruption of stored data after the high-speed mode pin 5 is brought into contact with a terminal of the normal connector 600 dedicated to the normal mode will not occur. Moreover, not only the hybrid SD memory card 120, but also the normal SD memory card 500 can be inserted into the high-speed mode compatible connector 220 and therefore, the pins 503 of the normal SD memory card 500 can be brought into contact with the normal mode pins 4.

### FOURTH EMBODIMENT

FIG. 23 is a diagram showing the configuration of an SD memory card as a semiconductor memory card according to a fourth embodiment. The SD memory card is configured, like the first to the third embodiments, by accommodating a substrate on which a memory package formed of a nonvolatile semiconductor memory such as an NAND-type flash memory and a memory controller that controls the memory package are mounted inside a case and thus, only differences from the first to the third embodiments will be described.

A hybrid SD memory card 130 has, like the second and the third embodiments, the rib 3 formed only on one side of the side surface and cannot be inserted into the card insertion hole 601 of the normal connector 600. The shape of the hybrid SD memory card 130 in a top sight or bottom sight is almost the same as that of the normal SD memory card 500, but the total length (length in a longitudinal direction) of the hybrid SD memory card 130 is longer than that of the normal SD memory card 500. Moreover, the thickness of the tip in this embodiment is thinner than that of the normal SD memory card 500. Here, the tip means a portion of the hybrid SD memory card 130 protruding from the normal SD memory card 500 when the hybrid SD memory card 130 and the normal SD memory card 500 are piled up vertically by aligning bottoms thereof.

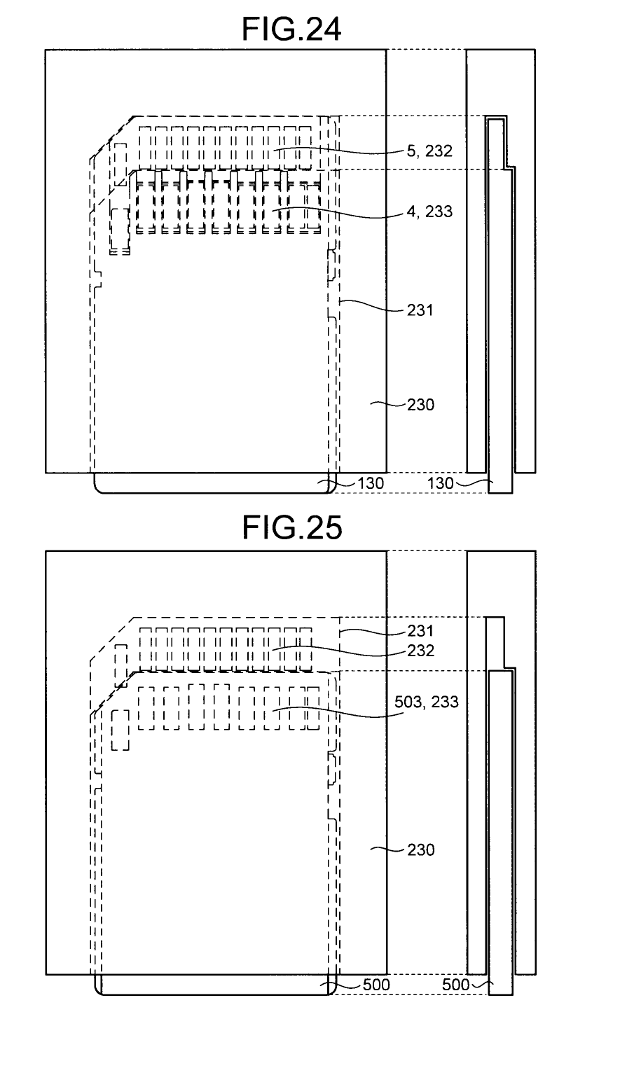

FIG. 24 is a diagram showing the state in which the hybrid SD memory card 130 is inserted into a card insertion hole 231 of a high-speed mode compatible connector 230 to read from/write into the hybrid SD memory card 130. By inserting the hybrid SD memory card 130 up to the back end of the card insertion hole 231, the high-speed mode pins 5 are arranged at a position corresponding to high-speed mode terminals 232 arranged near the back end of the card insertion hole 231. Also, by inserting the hybrid SD memory card 130 up to the back end of the card insertion hole 231, the normal mode pins 4 are arranged at a position corresponding to normal mode terminals 233 arranged on the opening side from the high-speed mode terminals 232.

FIG. 25 is a diagram showing the state in which the normal SD memory card 500 is inserted into the card insertion hole 231 of the high-speed mode compatible connector 230. The height dimension on the back end side of the card insertion hole 231 is smaller than the thickness of the normal SD memory card 500 and thus, the normal SD memory card 500 can be inserted up to some point where the height of the card insertion hole 231 changes. Thus, the pins 503 formed near the tip of the normal SD memory card 500 are arranged at a position corresponding to the normal mode terminals 233 arranged on the opening side from the point where the height of the card insertion hole 231 of the high-speed mode compatible connector 230 changes. Therefore, the normal SD memory card 500 can be inserted into the card insertion hole 231 of the high-speed mode compatible connector 230 to read/write data. Moreover, even if the normal SD memory card 500 is inserted into the card insertion hole 231, the normal SD memory card 500 does not reach an area where the high-speed mode terminals 232 are arranged and thus, there is not possibility that the normal SD memory card 500 erroneously comes into contact with the high-speed mode terminals 232 of the high-speed mode compatible connector 230.

Thus, the hybrid SD memory card 130 according to this embodiment cannot be inserted into the normal connector 600 at all and thus, malfunctions such as corruption of stored data after the high-speed mode pin 5 is brought into contact with a terminal of the normal connector 600 dedicated to the normal mode will not occur. Moreover, not only the hybrid SD memory card 130, but also the normal SD memory card 500 can be inserted into the high-speed mode compatible connector 230 and therefore, the pins 503 of the normal SD memory card 500 can be brought into contact with the normal mode pins 4.

### FIFTH EMBODIMENT

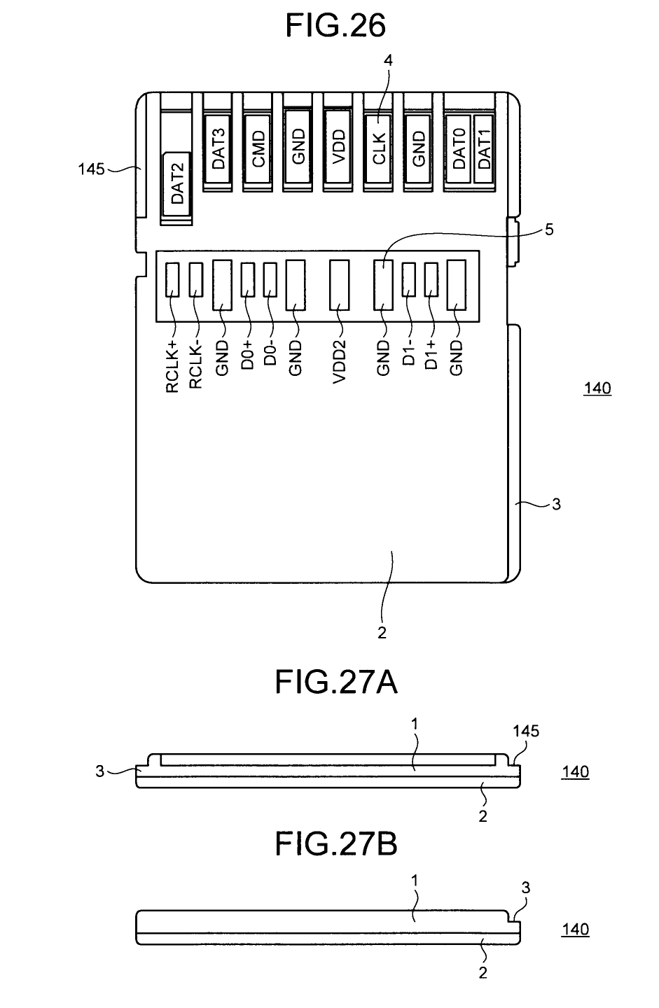

FIG. 26 is a diagram showing the configuration of an SD memory card as a semiconductor memory card according to a fifth embodiment. The SD memory card is configured, like the first to the fourth embodiments, by accommodating a substrate on which a memory package formed of a nonvolatile semiconductor memory such as an NAND-type flash memory and a memory controller that controls the memory package are mounted inside a case and thus, only differences from the first to the fourth embodiments will be described.

The width of a hybrid SD memory card 140 is the same as the width on the rear side from the neck 504 (the widest portion) of the normal SD memory card 500. The hybrid SD memory card 140 according to this embodiment has no neck. The hybrid SD memory card 140 has, like the second to the fourth embodiments, the rib 3 formed only on one side of the side surface and cannot be inserted into the card insertion hole 601 of the normal connector 600. A notch 145 is provided only in a tip portion (portion where normal mode pins are arranged) on the side surface on the side opposite to the side on which the rib 3 is formed. FIG. 27A is a diagram showing an appearance of the hybrid SD memory card 140 with a tip side thereof in an eye direction. FIG. 27B is a diagram showing the appearance of the hybrid SD memory card 140 with a rear side thereof in the eye direction.

The plurality of normal mode pins 4 used when the hybrid SD memory card 140 is caused to operate in normal mode is arranged near the tip on the down surface of the hybrid SD memory card 140 arrayed in a direction crossing the insertion direction. Also, the plurality of high-speed mode pins 5 used when the hybrid SD memory card 140 is caused to operate in high-speed mode is arranged in the rearward position from the area where the normal mode pins 4 of the hybrid SD memory card 140 are arranged arrayed in a direction crossing the insertion direction. For example, the differential clock signals RCLK+ and RCLK−, differential data signals D0+ and D0−, differential data signals D1+ and D1−, and power sources VDD2 and GND are assigned to the high-speed mode pins 5. By making the area of the signal pins (the differential clock signals RCLK±, differential data signals D0± and D1±) smaller than that of the power sources VDD2 and GND, GND and power can reliably be supplied and also realization of faster data transfer rate is made easier by making parasitic capacitance of a differential data pin smaller. By arranging the normal mode power pin (VDD) and the high-speed mode power pin (VDD2) adjacent to each other (positions thereof in the width direction of the SD memory card are the same), the power terminal of a connector compatible with the high-speed mode will not come into contact with the normal mode signal pin or GND pin. Accordingly, an abnormal operation (such as an overcurrent and latchup) due to a reverse bias caused after the power terminal of the connector comes into contact with the signal pin or GND pin can be prevented from occurring. Further, pin arrangement is created in such a way that the distance between the power pin and GND pin increases so that a problem of an increasing leak current when the distance between the power pin and GND pin is very small can be avoided.

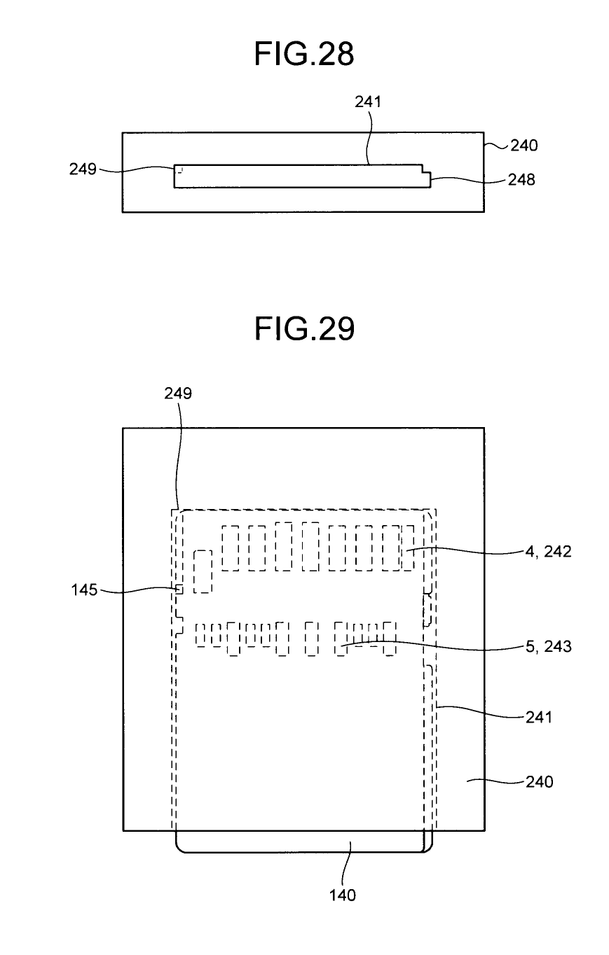

FIG. 28 is a diagram showing the shape of a high-speed mode compatible connector 240 used for reading/writing data from/to the hybrid SD memory card 140. A card insertion hole 241 of the high-speed mode compatible connector 240 has an opening shape corresponding to the shape in the front sight of the hybrid SD memory card 140 and has a groove 248 corresponding to the rib 3 formed on one inner wall. Also, a protrusion 249 corresponding to the notch 145 is formed near the back end of the inner wall on the side opposite to the side on which the groove 248 corresponding to the rib 3 is formed.

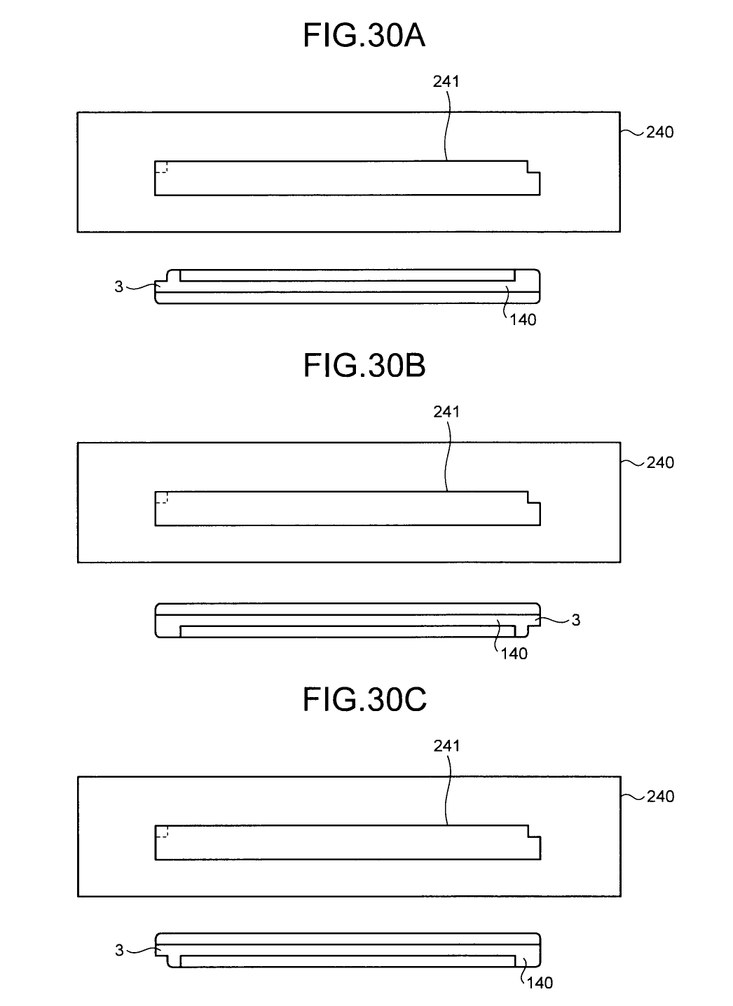

FIG. 29 is a diagram showing the state in which the hybrid SD memory card 140 is inserted into the card insertion hole 241 of the high-speed mode compatible connector 240. The card insertion hole 241 has the groove 248 corresponding to the rib 3 on one inner wall and thus, the hybrid SD memory card 140 can be inserted only if the hybrid SD memory card 140 is correctly oriented, both front and rear, up and down. The protrusion 249 is provided only near the back end on the inner wall on the side opposite to the side on which the groove 248 corresponding to the rib 3 is formed. The protrusion 249 has a shape corresponding to the notch 145 provided in the hybrid SD memory card 140 and the hybrid SD memory card 140 can be inserted up to the back end of the card insertion hole 241 without interfering with the protrusion 249. By inserting the hybrid SD memory card 140 up to the back end of the card insertion hole 241, the normal mode pins 4 are arranged at a position corresponding to normal mode terminals 242 arranged near the back end of the card insertion hole 241. Also, by inserting the hybrid SD memory card 140 up to the back end of the card insertion hole 241, the high-speed mode pins 5 are arranged at a position corresponding to high-speed mode terminals 243 arranged on the opening side from the normal mode terminals 242. Incidentally, as shown in FIGS. 30A, 30B, and 30C, the hybrid SD memory card 140 cannot be inserted into the card insertion hole 241 if oriented upside down or back-to-front because the rib 3 interferes with the opening of the card insertion hole 241 of the high-speed mode compatible connector 240.

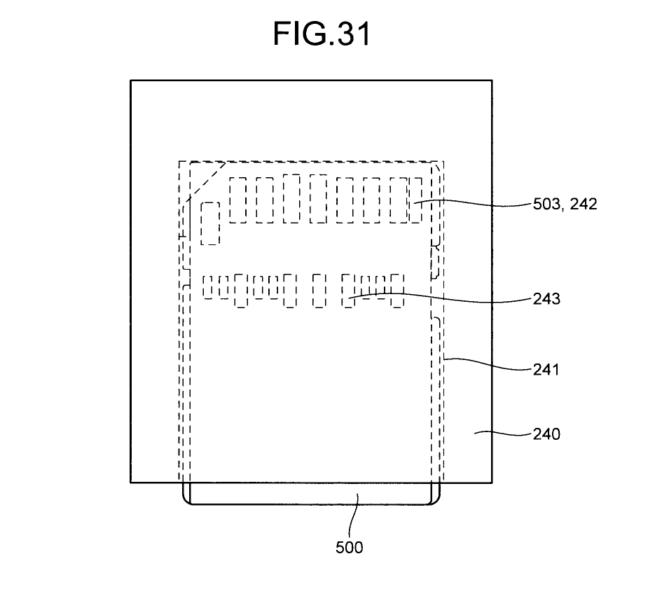

FIG. 31 is a diagram showing the state in which the normal SD memory card 500 is inserted into the card insertion hole 241 of the high-speed mode compatible connector 240. If correctly oriented, up and down, the normal SD memory card 500 can be inserted into the card insertion hole 241. However, if not correctly oriented, front and rear, the normal SD memory card 500 cannot be inserted up to the back end of the card insertion hole 241 because a rear end of the card interferes with the protrusion 249. If correctly oriented, both front and rear, up and down, the normal SD memory card 500 can be inserted up to the back end of the card insertion hole 241 without interfering with the protrusion 249 formed near the back end of the card insertion hole 241. If the normal SD memory card 500 is inserted up to the back end of the card insertion hole 241, the pins 503 formed near the tip of the normal SD memory card 500 are arranged at a position corresponding to the normal mode terminals 242 arranged near the back end of the card insertion hole 241. Therefore, the normal SD memory card 500 can be inserted into the card insertion hole 241 of the high-speed mode compatible connector 240 to read/write data. Moreover, the normal SD memory card 500 has no pin provided in an area corresponding to an area where the high-speed mode terminals 243 are arranged and thus, there is not possibility that the normal SD memory card 500 erroneously comes into contact with the high-speed mode terminals 243 of the high-speed mode compatible connector 240.

Thus, the hybrid SD memory card 140 according to this embodiment cannot be inserted into the normal connector 600 at all and thus, malfunctions such as corruption of stored data after the high-speed mode pin 5 is brought into contact with a terminal of the normal connector 600 dedicated to the normal mode will not occur. Moreover, not only the hybrid SD memory card 140, but also the normal SD memory card 500 can be inserted into the high-speed mode compatible connector 240 and therefore, the pins 503 of the normal SD memory card 500 can be brought into contact with the normal mode pins 4.

### SIXTH EMBODIMENT

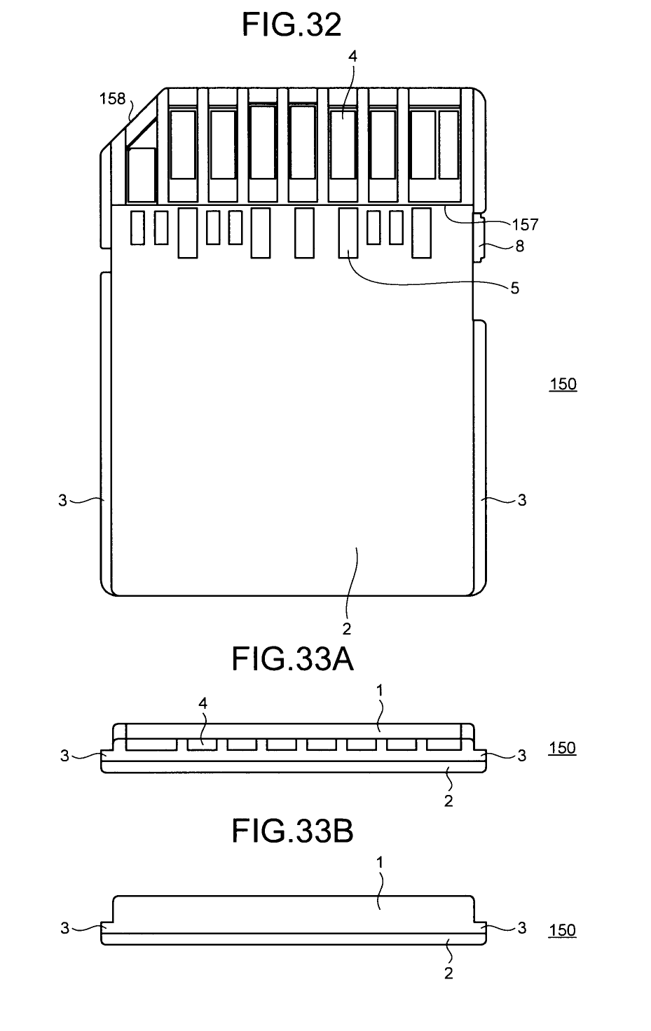

FIG. 32 is a diagram showing the configuration of an SD memory card as a semiconductor memory card according to a sixth embodiment. The SD memory card is configured, like the first to the fifth embodiments, by accommodating a substrate on which a memory package formed of a nonvolatile semiconductor memory such as an NAND-type flash memory and a memory controller that controls the memory package are mounted inside a case and thus, only differences from the first to the fifth embodiments will be described.

The plurality of normal mode pins 4 used when a hybrid SD memory card 150 is caused to operate in normal mode is arranged near the tip on the down surface of the hybrid SD memory card 150 arrayed in a direction crossing the insertion direction. Also, the plurality of high-speed mode pins 5 used when the hybrid SD memory card 150 is caused to operate in high-speed mode is arranged in the rearward position from the area where the normal mode pins 4 of the hybrid SD memory card 150 are arranged arrayed in a direction crossing the insertion direction. The shape near the tip of the hybrid SD memory card 150 in the top sight or bottom sight is almost the same as that of the normal SD memory card 500. More specifically, this means that when the hybrid SD memory card 150 and the normal SD memory card 500 are piled up vertically by superposing tip portions (on the side on which the normal mode pins 4 are arranged), both overlap each other without protrusion.

The hybrid SD memory card 150 has a step 157 formed in the thickness direction and the thickness on the tip side is the same as that of the normal SD memory card 500. However, the thickness of the hybrid SD memory card 150 increases at some midpoint toward the rear end. The thickness on the rear side from the step 157 of the hybrid SD memory card 150 is thicker than that of the normal SD memory card 500. That is, the hybrid SD memory card 150 is thicker than the normal SD memory card 500 in the rearward position from the area where the high-speed mode pins 5 are arranged.

The hybrid SD memory card 150 has a neck 158 provided with one side surface on the tip side slanted, tapering the hybrid SD memory card 150. The hybrid SD memory card 150 also has the rib 3 formed on both side surfaces. The plurality of normal mode pins 4 is arranged near the tip on the down surface of the hybrid SD memory card 150 in a direction crossing the insertion direction. Also, the plurality of high-speed mode pins 5 is arranged in the rearward position from the area where the normal mode pins 4 of the hybrid SD memory card 150 are arranged in a direction crossing the insertion direction. Here, the high-speed mode pins 5 are arranged in the rearward position from the step 157. The write protect switch 8 is formed on the side surface opposite to the side on which the neck 158 is formed. The hybrid SD memory card 150 is write-enabled when the write protect switch 8 is arranged on the tip side and write-disabled when the write protect switch 8 is arranged on the rear end side.

FIG. 33A is a diagram showing the appearance of the hybrid SD memory card 150 with the tip side thereof in the eye direction. FIG. 33B is a diagram showing the appearance of the hybrid SD memory card 150 with the rear side thereof in the eye direction.

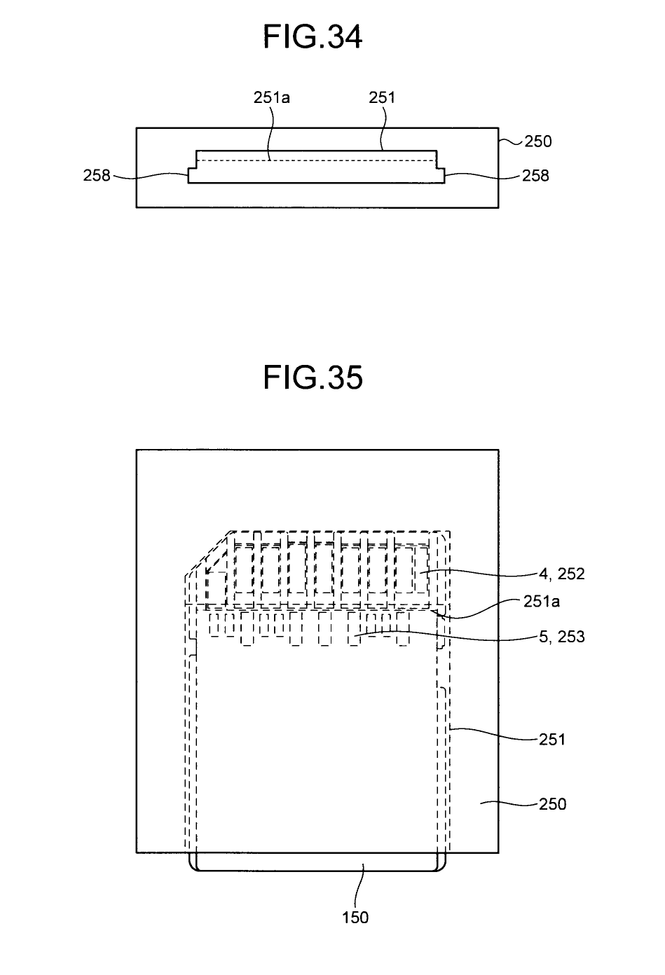

FIG. 34 is a diagram showing the shape of a high-speed mode compatible connector 250 used for reading/writing data from/to the hybrid SD memory card 150. A card insertion hole 251 of the high-speed mode compatible connector 250 has an opening shape corresponding to the shape in the front sight of the hybrid SD memory card 150 and has a groove 258 corresponding to the rib 3 formed on both inner walls. Thus, if correctly oriented, both front and rear, up and down, the hybrid SD memory card 150 can be inserted up to the back end of the card insertion hole 251 with the rib 3 fitted into the groove 258 of the card insertion hole 251. The shape of the card insertion hole 251 of the high-speed mode compatible connector 250 corresponds to that in the height direction of the hybrid SD memory card 150 and a step 251a is formed on the inner wall whose height decreases at some midpoint.

FIG. 35 is a diagram showing the state in which the hybrid SD memory card 150 is inserted into the card insertion hole 251 of the high-speed mode compatible connector 250. The opening shape of the card insertion hole 251 is like that in the first embodiment and includes the groove 258 corresponding to the rib 3 on both inner walls. The height near the opening of the card insertion hole 251 is a little larger than the thickness of the SD memory card 150 on the rear end side. However, the height dimension of the card insertion hole 251 decreases in a portion deeper than an area where high-speed mode terminals 253 are arranged at some midpoint in the depth direction (deeper than the step 251a), producing a height a little larger than the that of the normal SD memory card 500. The shape of the card insertion hole 251 of the high-speed mode compatible connector 250 corresponds to that of the hybrid SD memory card 150 in the width direction and the card insertion hole 251 becomes narrower at some midpoint. Thus, the hybrid SD memory card 150 can be inserted into the card insertion hole 251 only if correctly oriented, both front and rear, up and down.

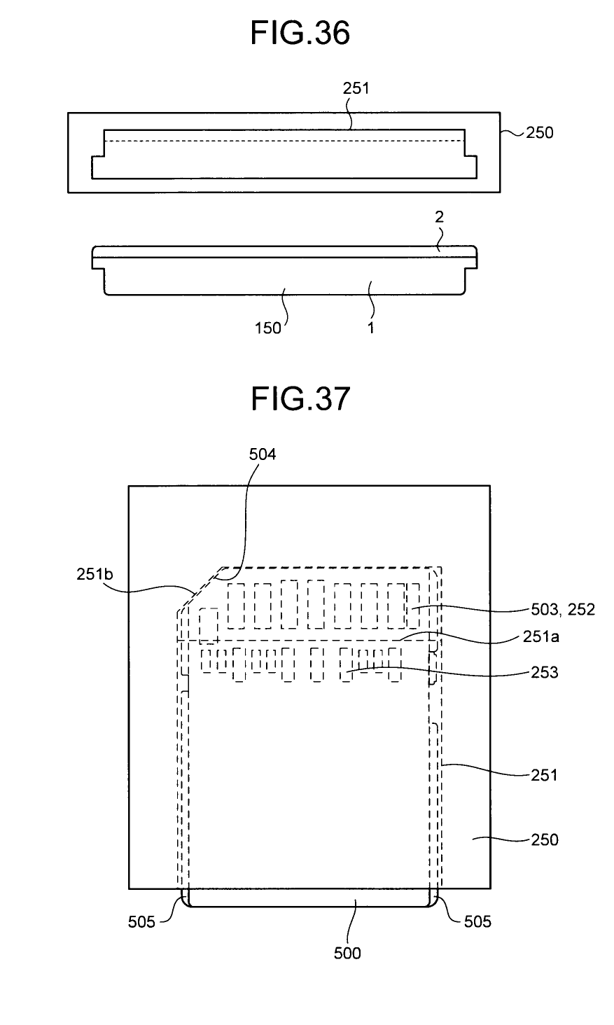

FIG. 36 is a diagram showing the state in which the rib 3 of the hybrid SD memory card 150 in a reversed state or a thick portion on the rear end side interferes with an opening edge of the card insertion hole 251. As shown in FIG. 36, the hybrid SD memory card 150 in a reversed state cannot be inserted into the card insertion hole 251 because the rib 3 interferes with an opening edge of the card insertion hole 251. If the hybrid SD memory card 150 is back-to-front, the hybrid SD memory card 150 cannot be inserted up to the back end of the card insertion hole 251 because the rear end thereof interferes with a location where the height decreases due to the step 251a. If the hybrid SD memory card 150 is correctly oriented, both front and rear, up and down, the hybrid SD memory card 150 can be inserted up to the back end of the card insertion hole 251. Then, the hybrid SD memory card 150 fits into the card insertion hole 251 of the high-speed mode compatible connector 250 with almost no gap and the normal mode pins 4 are arranged at a position corresponding to normal mode terminals 252 arranged near the back end of the card insertion hole 251. Moreover, the high-speed mode pins 5 are arranged at a position corresponding to high-speed mode terminals 253 arranged on the opening side from a portion where the width of the card insertion hole 251 decreases.

FIG. 37 is a diagram showing the state in which the normal SD memory card 500 is inserted into the card insertion hole 251 of the high-speed mode compatible connector 250. The height near the opening of the card insertion hole 251 of the high-speed mode compatible connector 250 is larger than the thickness of the normal SD memory card 500 and thus, a gap arises between the inserted normal SD memory card 500 and the inner wall of the card insertion hole 251. The normal SD memory card 500 is controlled in its movement in the vertical direction by the rib 505 formed on both side surfaces and thus, the normal SD memory card 500 is inserted up to the back end of the card insertion hole 251 without coming into contact with the step 251a inside the card insertion hole 251. The pins 503 formed near the tip of the normal SD memory card 500 are arranged at a position corresponding to the normal mode terminals 252 arranged near the back end of the card insertion hole 251 of the high-speed mode compatible connector 250. Moreover, the position of the normal SD memory card 500 when inserted is stabilized by the neck 504 of the normal SD memory card 500 being brought into contact with a step 251b on the inner wall of the card insertion hole 251. Therefore, the normal SD memory card 500 can be inserted into the card insertion hole 251 of the high-speed mode compatible connector 250 to read/write data. Moreover, the normal SD memory card 500 has no pin provided in an area corresponding to an area where the high-speed mode terminals 253 are arranged and thus, there is not possibility that the normal SD memory card 500 erroneously comes into contact with the high-speed mode terminals 253 of the high-speed mode compatible connector 250 after being inserted into the card insertion hole 251.

Thus, only a tip portion of the hybrid SD memory card 150 according to this embodiment can be inserted into the normal connector 600 and thus, malfunctions such as corruption of stored data after the high-speed mode pin 5 is brought into contact with a terminal of the normal connector 600 dedicated to the normal mode will not occur. Moreover, not only the hybrid SD memory card 150, but also the normal SD memory card 500 can be inserted into the high-speed mode compatible connector 250 and therefore, the pins 503 of the normal SD memory card 500 can be brought into contact with the normal mode pins 4.

The insertion direction of the hybrid SD memory card according to any of the first to the sixth embodiments is the same when the card is caused to operate in normal mode and when the card is caused to operate in high-speed mode and thus, there is no need for the user to intentionally change the insertion direction when the card is caused to operate in normal mode and when the card is caused to operate in high-speed mode. Thus, it is unlikely that the user inserts a hybrid SD memory card into a connector in erroneous orientation.

### SEVENTH EMBODIMENT

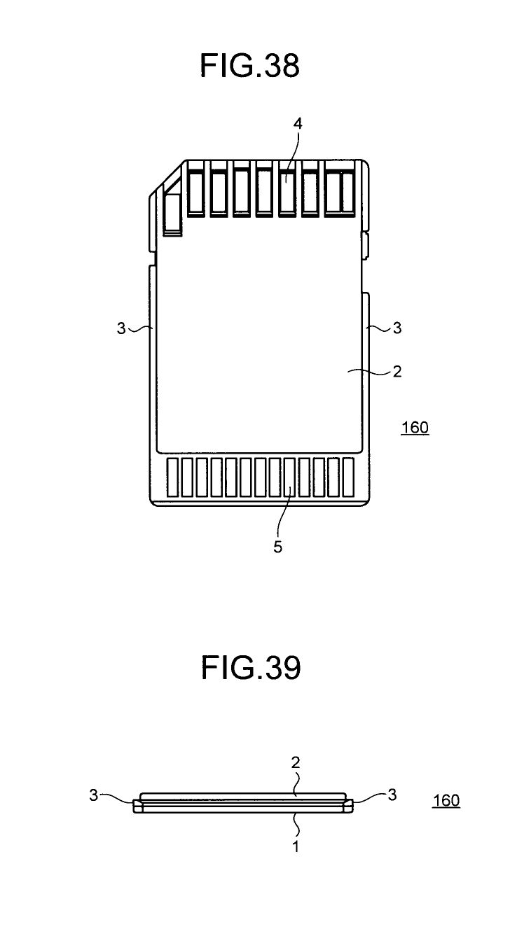

FIG. 38 is a diagram showing the configuration of an SD memory card as a semiconductor memory card according to a seventh embodiment. Here, the upward direction on paper in FIG. 38 is an insertion direction into a connector when a hybrid SD memory card 160 is caused to operate in normal mode and the upper side is defined as “front”. Similarly, the downward direction on paper in FIG. 38 is a removal direction from a connector when the hybrid SD memory card 140 is caused to operate in normal mode and the lower side is defined as “rear”. Further, a depth direction from paper in FIG. 38 is defined as “up” and a forward direction from paper is defined as “down”. When the hybrid SD memory card 160 is caused to operate in high-speed mode, the insertion/removal of the hybrid SD memory card 160 into/from a connector is reversed and so that the hybrid SD memory card 160 is inserted into the connector from the rear side and removed from the connector toward the front side. The hybrid SD memory card 160 is configured by accommodating a substrate (not shown) on which a memory package (not shown) formed of a nonvolatile semiconductor memory such as an NAND-type flash memory and a memory controller (not shown) that controls the memory package are mounted inside a case composed of the upper case 1 (not shown in FIG. 38) and the lower case 2.

FIG. 39 is a front view of the hybrid SD memory card 160. As shown in FIG. 39, the hybrid SD memory card 160 has the rib 3 formed on both side surfaces and the front sight thereof presents a substantially convex form with the width a little narrower on the down side. This is just like the normal SD memory card 500.

The plurality of normal mode pins 4 (corresponding to the first pin group) used when the hybrid SD memory card 160 is caused to operate in normal mode (when the memory controller is caused to read/write data from/to the memory package in normal mode) is arranged near the tip on the down surface of the hybrid SD memory card 160 arrayed in a direction crossing the insertion direction. Moreover, the plurality of high-speed mode pins 5 (corresponding to the second pin group) used when the hybrid SD memory card 160 is caused to operate in high-speed mode (when the memory controller is caused to read/write data from/to the memory package in high-speed mode) is arranged near the rear end on the down surface of the hybrid SD memory card 160 arrayed in a direction crossing the insertion direction. The portion where the high-speed mode pins 5 near the rear end of the hybrid SD memory card 160 is arranged is a thin wall portion and is thinner than the tip side (for example, as thick as the portion of the rib 3). The normal mode pins 4 and the high-speed mode pins 5 are an electrode pattern formed on the above substrate (not shown) and exposed on the down surface side of the hybrid SD memory card 160 through the opening provided in the lower case 2. The high-speed mode pins 5 are pins for transmitting/receiving a differential signal and are arranged more in number than the normal mode pins 4. Here, a configuration example in which the number of the high-speed mode pins 5 is larger than that of the normal mode pins 4 is shown, but the number of the high-speed mode pins 5 does not always have to be larger than that of the normal mode pins 4 and the number of the high-speed mode pins 5 can be made equal to or smaller than that of the normal mode pins 4.

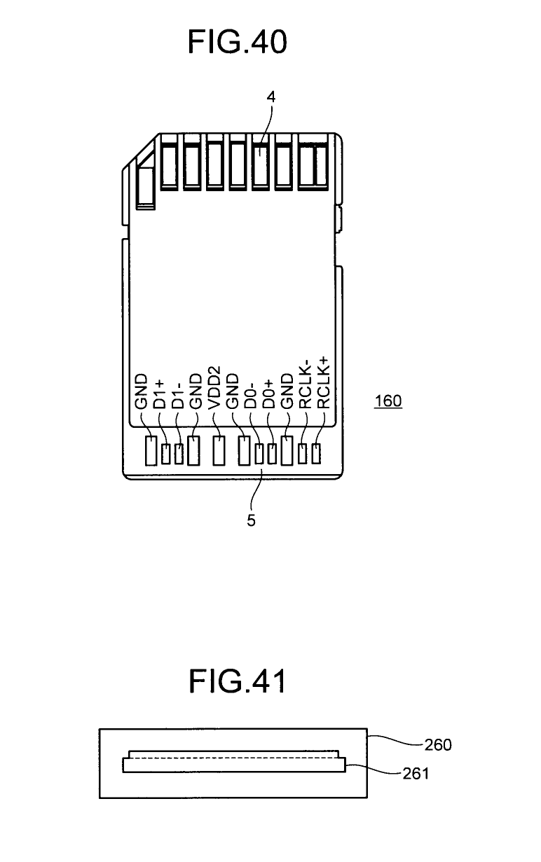

For example, the differential clock signals RCLK+ and RCLK−, differential data signals D0+ and D0−, differential data signals D1+ and D1−, and power sources VDD2 and GND are assigned to the high-speed mode pins 5. By making the area of the signal pins (the differential clock signals RCLK±, differential data signals D0± and D1±) smaller than that of the power sources VDD2 and GND, GND and power can reliably be supplied and also realization of faster data transfer rate is made easier by making parasitic capacitance of a differential data pin smaller. FIG. 40 is a diagram exemplifying the hybrid SD memory card 160 whose signal pin is made smaller compared with the power pin or the ground pin. Moreover, by arranging the normal mode power pin (VDD) and the high-speed mode power pin (VDD2) in such a way that positions thereof in the width direction of the SD memory card are the same, the power terminal of a connector compatible with the high-speed mode will not come into contact with the signal pin or GND pin for a different mode. Accordingly, an abnormal operation (such as an overcurrent and latchup) due to a reverse bias caused after the power terminal of the connector comes into contact with the signal pin or GND pin can be prevented from occurring.

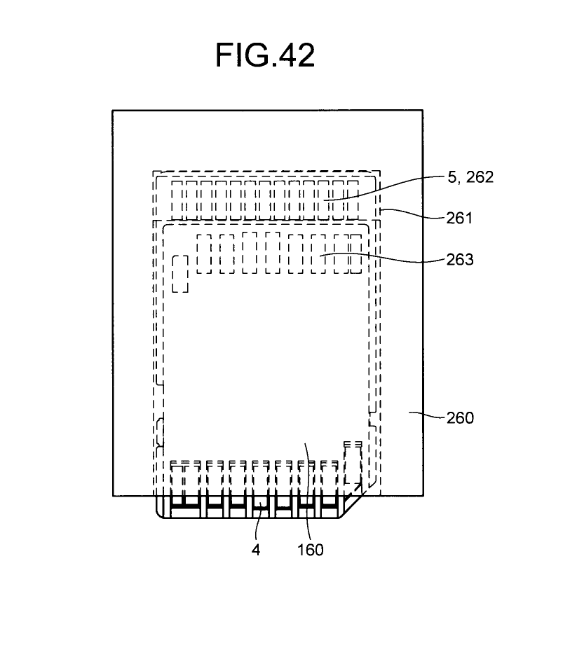

FIG. 41 is a diagram showing the opening shape of a connector (high-speed mode compatible connector) 260 compatible with the high-speed mode to read from/write into the hybrid SD memory card 160. The height of a card insertion hole 261 of the high-speed mode compatible connector 260 decreases on the back end side when viewed from the opening of the card insertion hole 261 and corresponds to the thin wall portion on the rear end side of the hybrid SD memory card 160. FIG. 42 is a diagram showing the state in which the hybrid SD memory card 160 is inserted into the card insertion hole 261 from the rear end side. As shown in FIG. 42, if the hybrid SD memory card 160 is inserted into the card insertion hole 261 from the rear end side, the hybrid SD memory card 160 can be inserted until the rear end of the hybrid SD memory card 160 reaches the back end of the card insertion hole 261. By inserting the hybrid SD memory card 160 until the rear end of the hybrid SD memory card 160 reaches the back end of the card insertion hole 261, the high-speed mode pins 5 are arranged at a position corresponding to high-speed mode terminals 262 arranged near the back end of the card insertion hole 261.

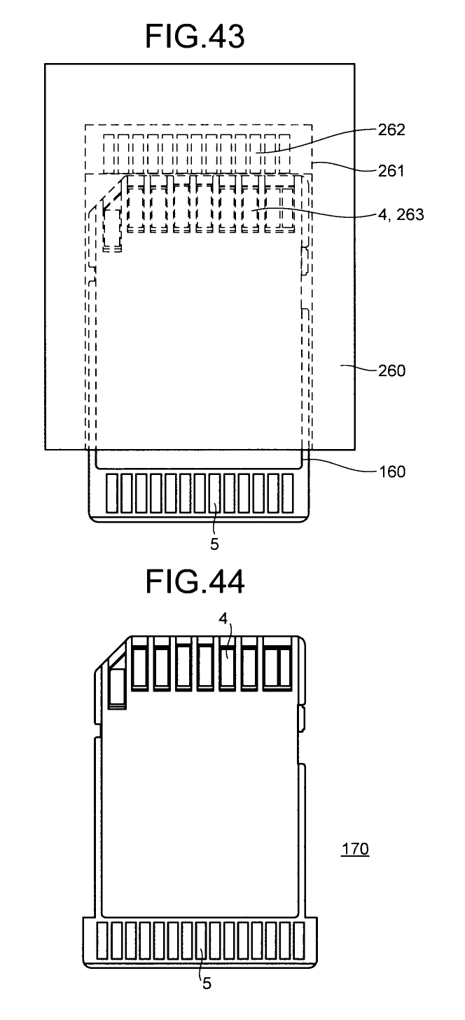

FIG. 43 is a diagram showing the state in which the hybrid SD memory card 160 is inserted into the card insertion hole 261 from the tip side. The tip side of the hybrid SD memory card 160 is not thinned and thus, if inserted into the card insertion hole 261 from the tip side, the hybrid SD memory card 160 can be inserted up to a position where the height of the card insertion hole 261 changes. Therefore, the normal mode pins 4 formed near the tip of the hybrid SD memory card 160 are arranged at a position corresponding to normal mode terminals 263 arranged on the opening side from the position where the height of the card insertion hole 261 of the high-speed mode compatible connector 260 changes.

The hybrid SD memory card 160 does not have any pin provided in an area corresponding to an area where the normal mode terminals 263 are arranged when inserted into the card insertion hole 261 from the rear end side and thus, there is not possibility that the hybrid SD memory card 160 erroneously comes into contact with the normal mode terminals 263 of the high-speed mode compatible connector 260. Conversely, when inserted into the card insertion hole 261 from the tip side, the hybrid SD memory card 160 does not reach an area where the high-speed mode terminals 262 are arranged and thus, there is not possibility that erroneously coming into contact with the high-speed mode terminals 262. Moreover, the high-speed mode terminals 262 do not come into contact with the body of the hybrid SD memory card 160. As a result, the possibility that the outer shape of the hybrid SD memory card 160 is damaged by contact between the high-speed mode terminals 262 and the body of the hybrid SD memory card 160 can be reduced. Also, durability of the high-speed mode terminals 262 can be improved. Furthermore, when the hybrid SD memory card 160 is inserted into the card insertion hole 261 from the tip side, friction of the high-speed mode terminals 262 can be avoided. As a result, when the hybrid SD memory card 160 is inserted into the card insertion hole 261 from the tip side, the hybrid SD memory card 160 can be inserted easily.

The hybrid SD memory card 160 does not have any neck formed on the rear end thereof and thus, can be inserted into the card insertion hole 601 of the normal connector 600 up to some midpoint. Therefore, malfunctions such as corruption of recorded data after the high-speed mode pin 5 is brought into contact with a pin of the normal connector 600 dedicated to the normal mode will not occur. Moreover, not only the hybrid SD memory card 160, but also the normal SD memory card 500 can be inserted into the high-speed mode compatible connector 260 and therefore, the pins 503 of the normal SD memory card 500 can be brought into contact with the normal mode pins 4.

### EIGHTH EMBODIMENT

FIG. 44 is a diagram showing the configuration of an SD memory card as a semiconductor memory card according to an eighth embodiment. Like the seventh embodiment, the plurality of normal mode pins 4 used when a hybrid SD memory card 170 is caused to operate in normal mode is arranged near the tip on the down surface of the hybrid SD memory card 170 arrayed in a direction crossing the insertion direction and the plurality of high-speed mode pins 5 used when the hybrid SD memory card 170 is caused to operate in high-speed mode is arranged near the rear end on the down surface of the hybrid SD memory card 170 arrayed in a direction crossing the insertion direction. The hybrid SD memory card 170 has a width wider on the rear end side than on the tip side. The tip portion of the hybrid SD memory card 170 is the same as that of the normal SD memory card 500. More specifically, this means that when the hybrid SD memory card 170 and the normal SD memory card 500 are piled up vertically by aligning tip portions on the side on which the normal mode pins 4 are arranged, the overlapped portions are the same. Otherwise, the eighth embodiment is the same as the seventh embodiment.

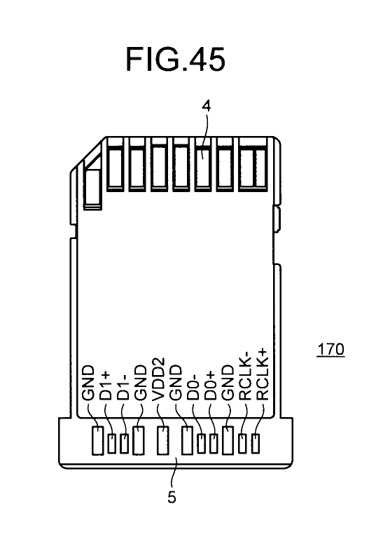

Like the seventh embodiment, for example, the differential clock signals RCLK+ and RCLK−, differential data signals D0+ and D0−, differential data signals D1+ and D1−, and power sources VDD2 and GND are assigned to the high-speed mode pins 5. By making the area of the signal pins (the differential clock signals RCLK±, differential data signals D0± and D1±) smaller than that of the power sources VDD2 and GND, GND and power can reliably be supplied and also realization of faster data transfer rate is made easier by making parasitic capacitance of a differential data pin smaller. FIG. 45 is a diagram exemplifying the hybrid SD memory card 170 whose signal pin is made smaller compared with the power pin or the ground pin. Moreover, by arranging the normal mode power pin (VDD) and the high-speed mode power pin (VDD2) in such a way that positions thereof in the width direction of the SD memory card are the same, the power terminal of a connector compatible with the high-speed mode will not come into contact with the signal pin or GND pin for a different mode. Accordingly, an abnormal operation (such as an overcurrent and latchup) due to a reverse bias caused after the power terminal of the connector comes into contact with the signal pin or GND pin can be prevented from occurring.

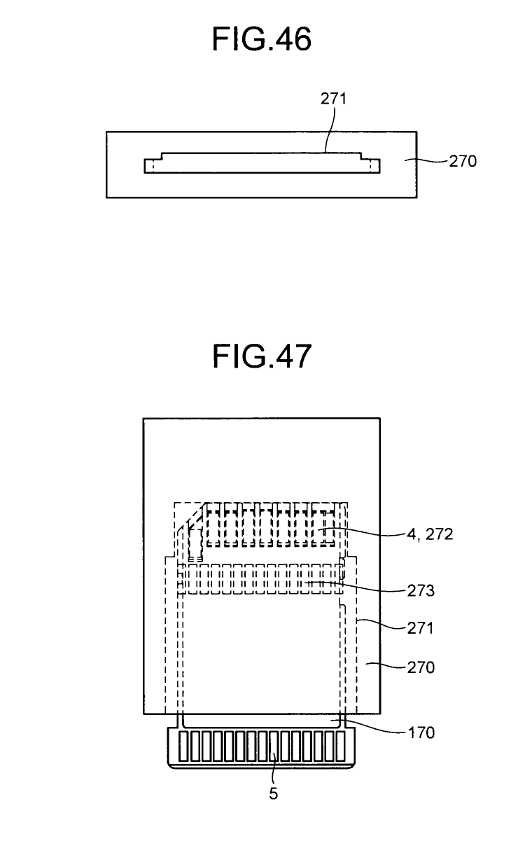

FIG. 46 is a diagram showing the opening shape of a high-speed mode compatible connector 270 to read from/write into the hybrid SD memory card 170. As shown in FIG. 46, the width of a card insertion hole 271 of the high-speed mode compatible connector 270 is narrower on the back end side when viewed from the opening of the card insertion hole 271 and the width on the opening side is the same as that on the rear end side of the hybrid SD memory card 170. The width of a narrower portion of the card insertion hole 271 is the same as that on the tip side of the hybrid SD memory card 170.

FIG. 47 is a diagram showing the state in which the hybrid SD memory card 170 is inserted into the card insertion hole 271 of the high-speed mode compatible connector 270 from the tip side. In contrast to the seventh embodiment, if the hybrid SD memory card 170 is inserted into the card insertion hole 271 from the tip side, the hybrid SD memory card 170 can be inserted until the tip thereof reaches the back end of the card insertion hole 271. By inserting the tip of the hybrid SD memory card 170 until the back end of the card insertion hole 271 is reached, the normal mode pins 4 are arranged at a position corresponding to normal mode terminals 272 arranged near the back end of the card insertion hole 271.

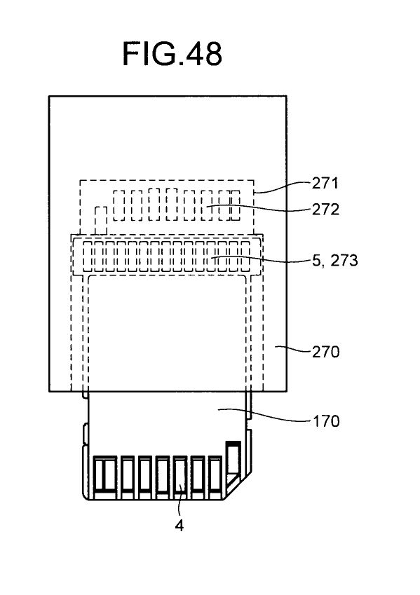

FIG. 48 is a diagram showing the state in which the hybrid SD memory card 170 is inserted into the card insertion hole 271 from the rear end side. If the hybrid SD memory card 170 is inserted into the card insertion hole 271 from the rear end side, the hybrid SD memory card 170 can be inserted only up to a position where the width of the card insertion hole 271 changes. Thus, the high-speed mode pins 5 formed near the rear end of the hybrid SD memory card 170 can be arranged at a position corresponding to high-speed mode terminals 273 arranged on the opening side from the position where the width of the card insertion hole 271 changes.

The hybrid SD memory card 170 does not have any pin provided in an area corresponding to an area where the high-speed mode terminals 273 are arranged if inserted into the card insertion hole 271 from the tip side and thus, there is not possibility that the hybrid SD memory card 170 erroneously comes into contact with the high-speed mode terminals 273 of the high-speed mode compatible connector 270. Conversely, if the hybrid SD memory card 170 is inserted into the card insertion hole 271 from the rear end side, the hybrid SD memory card 170 does not reach the area where the normal mode terminals 272 are arranged and thus, there is not possibility that the hybrid SD memory card 170 erroneously comes into contact with the normal mode terminals 272.

The width of the hybrid SD memory card 170 is wider than that of the normal SD memory card 500 and thus, cannot be inserted into the normal connector 600. Therefore, malfunctions such as corruption of stored data after the high-speed mode pin 5 is brought into contact with a terminal of the normal connector 600 dedicated to the normal mode will not occur. Moreover, not only the hybrid SD memory card 170, but also the normal SD memory card 500 can be inserted into the high-speed mode compatible connector 270 and therefore, the pins 503 of the normal SD memory card 500 can be brought into contact with the normal mode pins 4.

A hybrid SD memory card according to the seventh or eighth embodiment has different insertion depths between when inserted into a high-speed mode compatible connector from the tip side and when inserted into a high-speed mode compatible connector from the rear end side. That is, when inserted into a high-speed mode compatible connector from the tip side or rear end side, the insertion is restricted at some midpoint of the card insertion hole and pins on the card side and terminals of the corresponding type on the connector side come into contact at that position. Insertion depths between when inserted into a connector from the tip side and when inserted into a connector from the rear end side are different and thus, pins and connectors that do not match can be prevented from being erroneously brought into contact. Accordingly, data inside the SD memory card can be prevented from being corrupted.

### NINTH EMBODIMENT

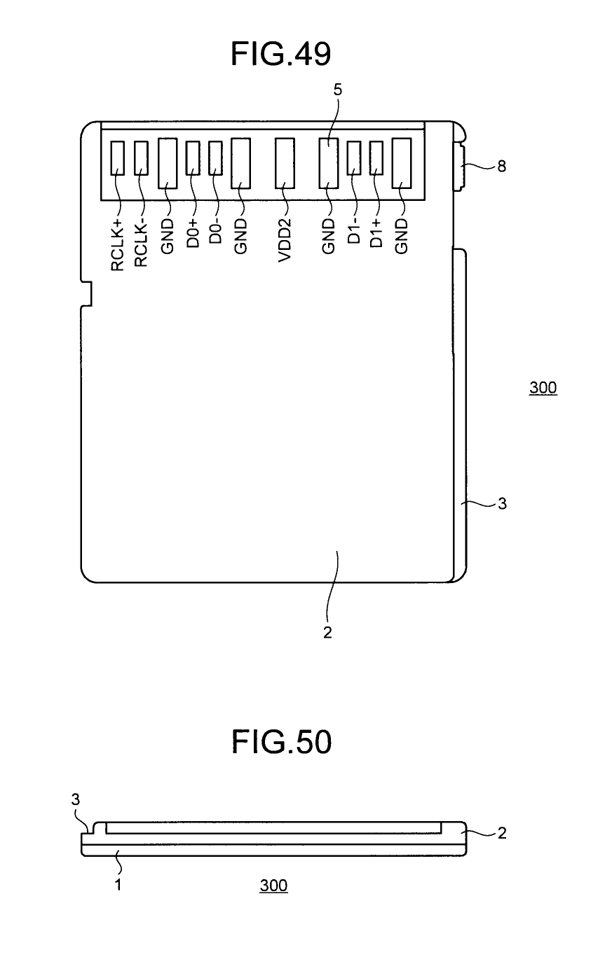

FIG. 49 is a diagram showing the configuration of an SD memory card as a semiconductor memory card according to a ninth embodiment. The SD memory card according to this embodiment is an SD memory card (high-speed SD memory card) that operates only in high-speed mode. Here, the upward direction on paper in FIG. 49 is an insertion direction into a connector and the upper side is defined as “front”. Similarly, the downward direction on paper in FIG. 49 is a removal direction from a connector and the lower side is defined as “rear”. Further, a depth direction from paper in FIG. 49 is defined as “up” and a forward direction from paper is defined as “down”. The hybrid SD memory card 100 is configured by accommodating a substrate (not shown) on which a memory package (not shown) formed of a nonvolatile semiconductor memory such as an NAND-type flash memory and a memory controller (not shown) that controls the memory package are mounted inside a case composed of the upper case 1 (not shown in FIG. 49) and the lower case 2.

FIG. 50 is a front view of a high-speed SD memory card 300. As shown in FIG. 50, the high-speed SD memory card 300 has the rib 3 formed only on one side and the width thereof is a little narrower on the down side.

The high-speed SD memory card 300 is substantially rectangular in the top sight and has no neck formed thereon. The width of the high-speed SD memory card 300 is the same as the width on the rear side from the neck of the normal SD memory card 500 (width of the widest portion). The high-speed SD memory card 300 has the write protect switch 8 formed near the tip thereof on the side surface on the side on which the rib 3 is formed. The high-speed SD memory card 300 is write-disabled when the write protect switch 8 is arranged on the tip side and write-enabled when the write protect switch 8 is arranged on the rear end side. The plurality of high-speed mode pins 5 (corresponding to the second pin group) used when the high-speed SD memory card 300 is caused to operate in high-speed mode (when the memory controller is caused to read/write data from/to the memory package in high-speed mode) is arranged near the tip on the down surface of the high-speed SD memory card 300 arrayed in a direction crossing the insertion direction. The high-speed mode pins 5 are an electrode pattern formed on the above substrate (not shown) and exposed on the down surface side of the high-speed SD memory card 300 through an opening provided in the lower case 2. The high-speed mode pins 5 are pins for transmitting/receiving a differential signal. For example, the differential clock signals RCLK+ and RCLK−, differential data signals D0+ and D0−, differential data signals D1+ and D1−, and power sources VDD2 and GND are assigned to the high-speed mode pins 5. The signal pins are made smaller compared to the source pin and the ground pin. By making the area of the signal pins (the differential clock signals RCLK±, differential data signals D0± and D1±) smaller than that of the power sources VDD2 and GND, parasitic capacitance is made smaller and realization of faster data transfer rate is made easier.

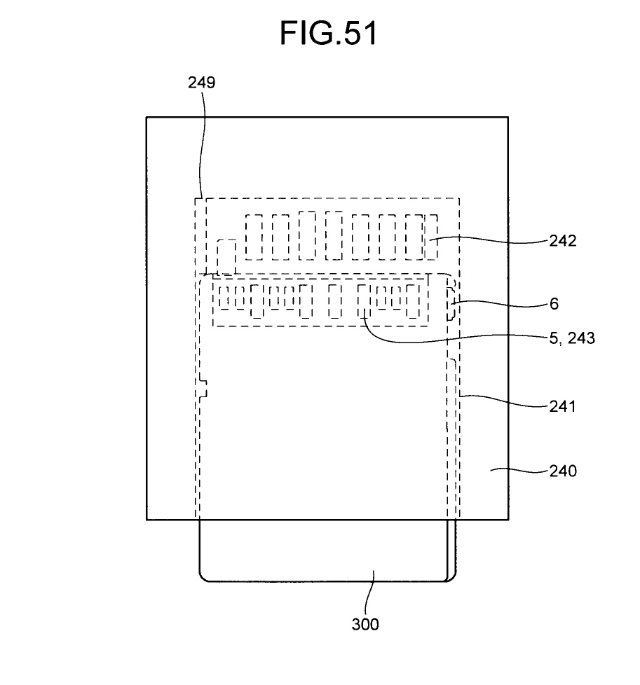

The high-speed SD memory card 300 can be inserted into the high-speed mode compatible connector 240 like in the fifth embodiment to read/write data. It is assumed, however, that the high-speed mode terminals 243 are arranged at a position corresponding to the high-speed mode pins 5 of the high-speed SD memory card 300. FIG. 51 is a diagram showing the state in which the high-speed SD memory card 300 is inserted into the card insertion hole 241 of the high-speed mode compatible connector 240 according to the above fifth embodiment. The high-speed SD memory card 300 inserted into the card insertion hole 241 interferes with the protrusion 249 to restrict further insertion thereof at some midpoint of the card insertion hole 241. The high-speed mode pins 5 arranged at the tip in the insertion direction of the high-speed SD memory card 300 come into contact with the high-speed mode terminals 243 at the position where the insertion is restricted. The position where the write protect switch 8 is arranged when the high-speed SD memory card 300 is inserted into the card insertion hole 241 while write enabled and the position where the write protect switch 8 is arranged when the hybrid SD memory card 140 is inserted into the card insertion hole 241 while write enabled are the same. Thus, the high-speed mode compatible connector 240 can perform a write-protect operation of data without distinguishing the hybrid SD memory card 140 and the high-speed SD memory card 300. Thus, the high-speed SD memory card 300 can be used in the high-speed mode compatible connector 240 compatible with the normal mode and the high-speed mode.

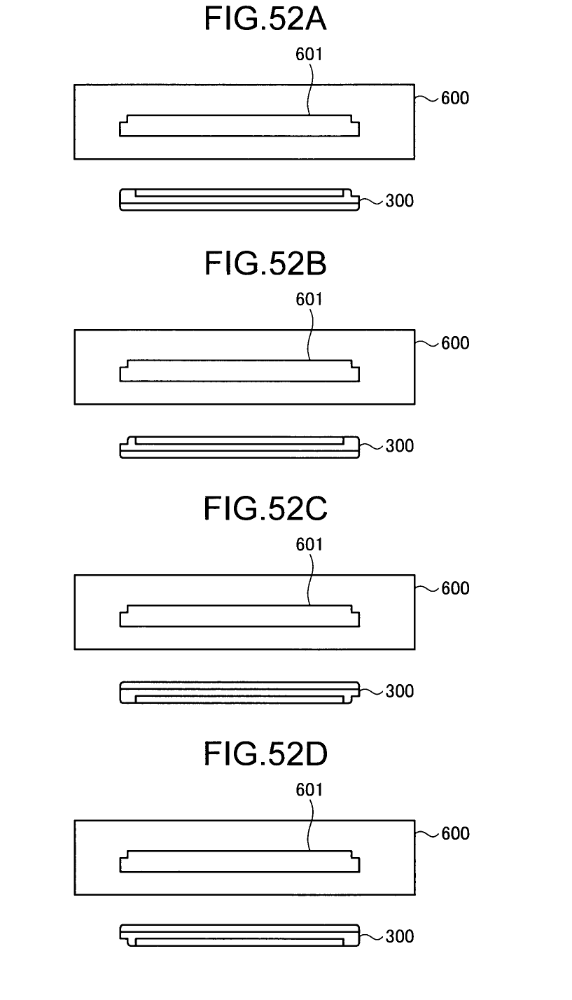

FIGS. 52A to 52D are diagrams showing the relationship between the opening shape of the card insertion hole 601 of the normal connector 600 and the sectional shape of the high-speed SD memory card 300. The high-speed SD memory card 300 will interfere with an opening edge (see FIG. 7) of the card insertion hole 601 of the normal connector 600 regardless of how the orientation thereof is changed, front and rear, up and down. That is, the width of the high-speed SD memory card 300 is the same as that of the normal SD memory card 500, but the rib 3 is formed only on one side surface and thus, the high-speed SD memory card 300 cannot be inserted into the card insertion hole 601 of the normal connector 600 regardless of how the high-speed SD memory card 300 is oriented.

The opening shape of the card insertion hole of a connector (high-speed connector) dedicated to data transfer in high-speed mode is the same as that of the card insertion hole 241 of the high-speed mode compatible connector 240 shown in FIG. 28. That is, the opening shape of the card insertion hole of the high-speed connector is a shape corresponding to the front sight of the high-speed SD memory card 300 and has a groove corresponding to the rib 3 formed only on one inner wall. Thus, the high-speed SD memory card 300 cannot be inserted into the card insertion hole of the high-speed connector if the high-speed SD memory card 300 is not correctly oriented, front and rear, up and down. It is needless to say that if the high-speed SD memory card 300 is inserted into the card insertion hole of the high-speed connector in correct orientation, high-speed mode terminals of the high-speed connector and the high-speed mode pins 5 of the high-speed SD memory card 300 come into contact at a predetermined depth to enable data transfer in high-speed mode.

The shape of the high-speed connector is the same as that obtained by removing a portion toward the back from the protrusion 249 of the high-speed mode compatible connector 240 shown in FIG. 29. That is, the position of the back end of the high-speed connector is a position corresponding to the position where the protrusion 249 of the high-speed mode compatible connector 240 is provided.

A high-speed SD memory card according to this embodiment includes terminals that cause a memory controller to read/write data from/to a memory package in high-speed mode and thus, a speedup of the data transfer rate can be realized. Moreover, the high-speed SD memory card according to this embodiment can be inserted into a high-speed mode compatible connector or high-speed connector to transfer data in high-speed mode, but cannot be inserted into a normal connector. Furthermore, when inserted into the high-speed mode compatible connector, the high-speed SD memory card according to this embodiment is restricted in insertion at some midpoint so that high-speed mode pins of the high-speed SD memory card according to this embodiment and normal mode terminals do not come into contact. Therefore, high-speed mode terminals of the high-speed SD memory card according to this embodiment will not erroneously come into contact with normal mode pins of a normal connector.

### TENTH EMBODIMENT

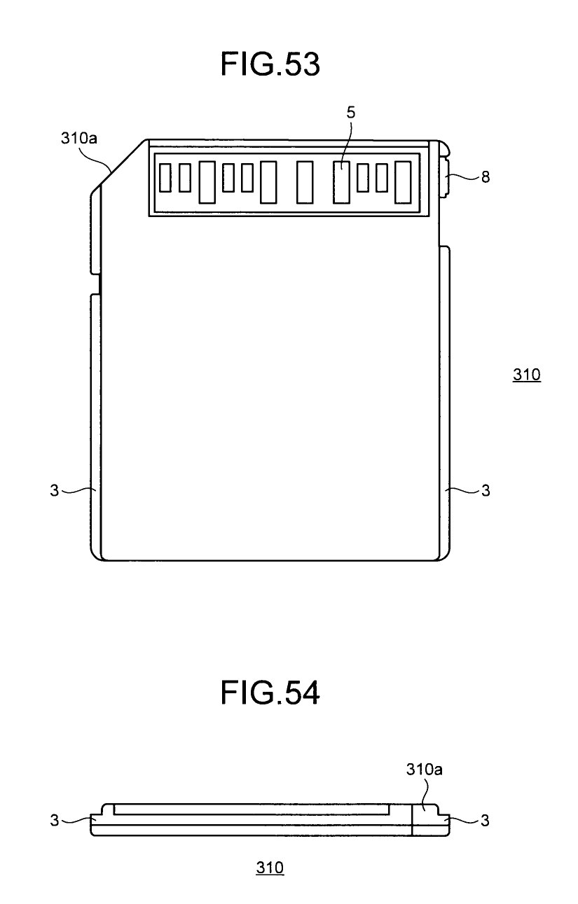

An SD memory card according to a tenth embodiment is configured, like the ninth embodiment, by accommodating a substrate on which a memory package formed of a nonvolatile semiconductor memory such as an NAND-type flash memory and a memory controller that controls the memory package are mounted inside a case and thus, differences from the ninth embodiment will be described. FIG. 53 is a diagram showing the configuration of a high-speed SD memory card as a semiconductor memory card according to the tenth embodiment. A high-speed SD memory card 310 has a neck 310a provided with one side surface on the tip side slanted, tapering the high-speed SD memory card 310. The width in the tip portion is wider than that of the normal SD memory card 500. That is, the high-speed SD memory card 310 is in any portion wider than the normal SD memory card 500. The write protect switch 8 is provided on the side surface on the side opposite to the side on which the neck 310a is provided. The high-speed SD memory card 310 is write-disabled when the write protect switch 8 is arranged on the tip side and write-enabled when the write protect switch 8 is arranged on the rear end side.

FIG. 54 is a front view of the high-speed SD memory card 310. As shown in FIG. 54, the high-speed SD memory card 310 has the rib 3 formed on both side surfaces and the front sight thereof presents a substantially convex form with the width a little narrower on the up side.

The width of the hybrid SD memory card 100 on the rear side from the step 6a (width of the widest portion) is similar to that of the high-speed SD memory card 310 on the rear side from the step 310a (width of the widest portion). More specifically, this means that when the hybrid SD memory card 100 and the high-speed SD memory card 310 are piled up vertically by superposing tip portions on the side opposite to the side on which the normal mode pins 4 are arranged, shapes on the rear side from the step 6a are the same.

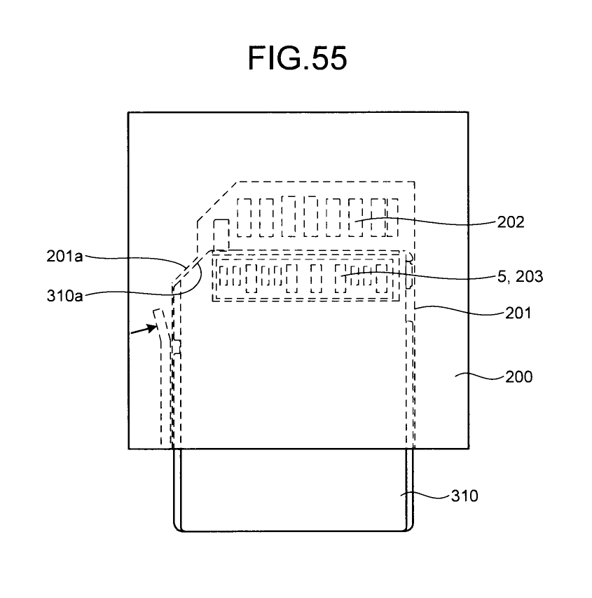

The high-speed SD memory card 310 can be inserted into the high-speed mode compatible connector 200 like in the first embodiment to read/write data. It is assumed, however, that the high-speed mode terminals 203 are arranged at a position corresponding to the high-speed mode pins 5 of the high-speed SD memory card 310. FIG. 55 is a diagram showing the state in which the high-speed SD memory card 310 is inserted into the card insertion hole 201 of the high-speed mode compatible connector 200. The high-speed SD memory card 310 inserted into the card insertion hole 201 interferes with the step 201a to restrict further insertion thereof at some midpoint of the card insertion hole 201. The high-speed mode pins 5 arranged at the tip in the insertion direction of the high-speed SD memory card 310 come into contact with the high-speed mode terminals 203 at the position where the further insertion is restricted due to interference of the neck 310a with the step 201a. The position where the write protect switch 8 is arranged when the high-speed SD memory card 310 is inserted into the card insertion hole 201 while write enabled and the position where the write protect switch 8 is arranged when the hybrid SD memory card 100 is inserted into the card insertion hole 201 while write enabled are the same. Thus, the high-speed mode compatible connector 200 can perform a write-protect operation of data without distinguishing the hybrid SD memory card 100 and the high-speed SD memory card 310. Thus, the high-speed SD memory card 310 can be used in the high-speed mode compatible connector 200 compatible with the normal mode and the high-speed mode.

Moreover, the normal mode terminals 202 do not come into contact with the body of the high-speed SD memory card 310. As a result, the possibility that the outer shape of the high-speed SD memory card 310 is damaged by contact between the normal mode terminals 202 and the body of the high-speed SD memory card 310 can be reduced. Also, durability of the normal mode terminals 202 can be improved. Furthermore, when the high-speed SD memory card 310 is inserted into the card insertion hole 201 from the tip side, friction of the normal mode terminals 202 can be avoided. As a result, when the high-speed SD memory card 310 is inserted into the card insertion hole 201 from the tip side, the high-speed SD memory card 310 can be inserted easily.

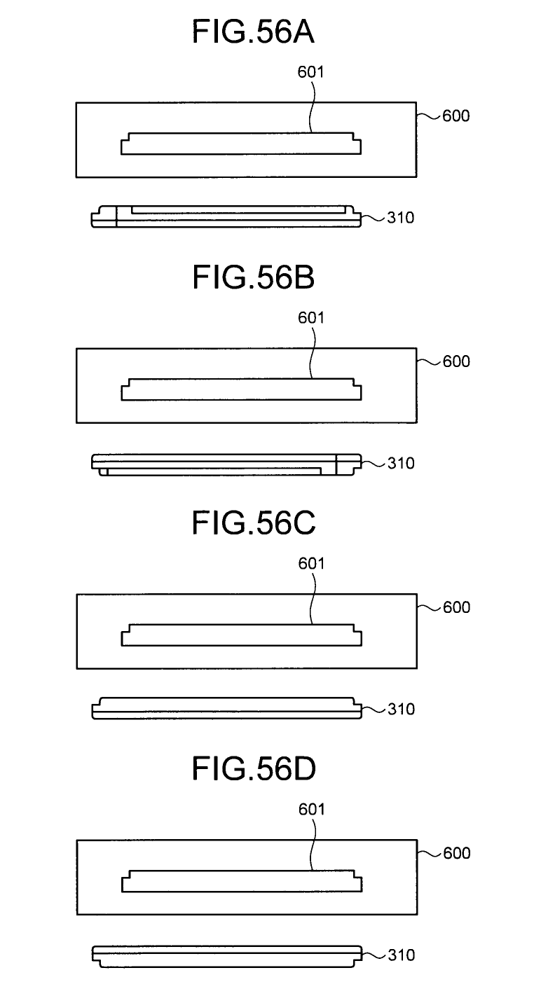

FIGS. 56A to 56D are diagrams showing the relationship between the opening shape of the card insertion hole 601 of the normal connector 600 and the sectional shape of the high-speed SD memory card 310. The width of the high-speed SD memory card 310 is wider than that of the normal SD memory card 500 and thus will interfere with an opening edge (see FIG. 7) of the card insertion hole 601 of the normal connector 600 regardless of how the orientation of the high-speed SD memory card 310 is changed, front and rear, up and down. That is, the high-speed SD memory card 310 cannot be inserted into the card insertion hole 601 of the normal connector 600 regardless of how the high-speed SD memory card 310 is oriented.

The opening shape of the card insertion hole of a connector (high-speed connector) dedicated to a high-speed SD memory card is the same as that of the card insertion hole 201 of the high-speed mode compatible connector 200 shown in FIG. 11. That is, the opening shape of the card insertion hole of the high-speed connector is a shape corresponding to the front sight of the high-speed SD memory card 310 and has a groove corresponding to the rib 3 formed on both inner walls. Thus, the high-speed SD memory card 310 cannot be inserted into the card insertion hole if the high-speed SD memory card 310 is oriented upside down. If the high-speed SD memory card 310 is oriented back-to-front, the high-speed SD memory card 310 can be inserted up to the step 201a. It is needless to say that if the high-speed SD memory card 310 is inserted into the card insertion hole of the high-speed connector in correct orientation, high-speed mode terminals of the high-speed connector and the high-speed mode pins 5 of the high-speed SD memory card 310 come into contact at a predetermined depth to enable data transfer in high-speed mode.

The shape of the high-speed connector is the same as that obtained by removing a portion toward the back from a side surface portion 201c of the high-speed mode compatible connector 200 shown in FIG. 12. That is, the position of the back end of the high-speed connector is a position corresponding to the position where the step 201a of the high-speed mode compatible connector 200 is provided.

A high-speed SD memory card according to this embodiment includes terminals that cause a memory controller to read/write data from/to a memory package in high-speed mode and thus, a speedup of the data transfer rate can be realized. Moreover, the high-speed SD memory card according to this embodiment can be inserted into a high-speed mode compatible connector or high-speed connector to transfer data in high-speed mode, but cannot be inserted into a normal connector. Therefore, high-speed mode terminals of the high-speed SD memory card according to this embodiment will not erroneously come into contact with normal mode pins of a normal connector.

### ELEVENTH EMBODIMENT

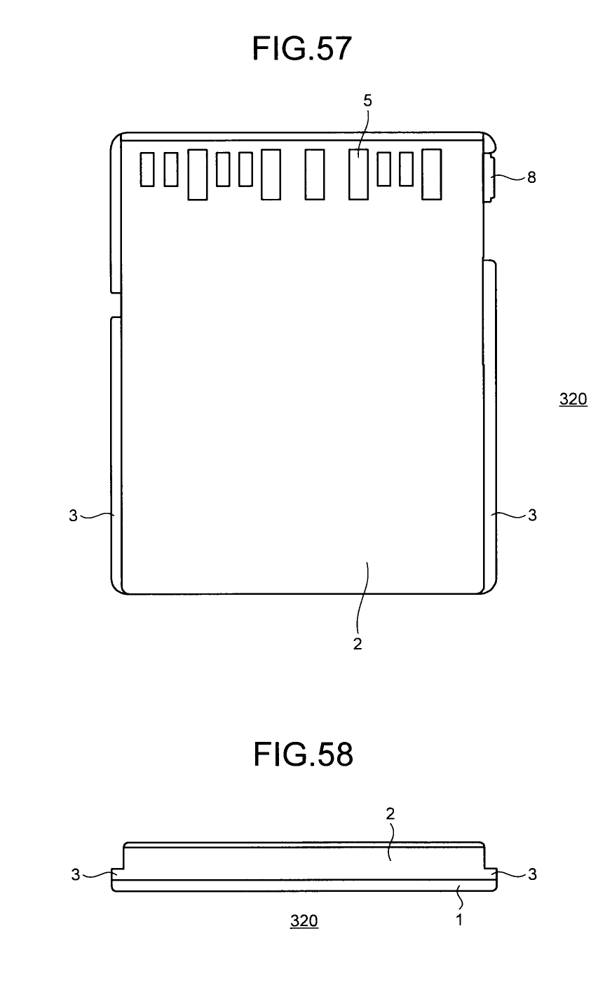

An SD memory card according to an eleventh embodiment is configured, like the ninth embodiment, by accommodating a substrate on which a memory package formed of a nonvolatile semiconductor memory such as an NAND-type flash memory and a memory controller that controls the memory package are mounted inside a case and thus, differences from the ninth embodiment will be described. FIG. 57 is a diagram showing the configuration of a high-speed SD memory card as a semiconductor memory card according to the eleventh embodiment. A high-speed SD memory card 320 is substantially rectangular in the top sight and has no neck formed thereon. The plurality of high-speed mode pins 5 is arranged near the tip on the down surface of the high-speed SD memory card 320 in a direction crossing the insertion direction. Moreover, the write protect switch 8 is formed near the tip on one side surface. The high-speed SD memory card 320 is write-disabled when the write protect switch 8 is arranged on the tip side and write-enabled when the write protect switch 8 is arranged on the rear end side.

FIG. 58 is a front view of the high-speed SD memory card 320. As shown in FIG. 58, the high-speed SD memory card 320 has the rib 3 formed on both side surfaces and the front sight thereof presents a substantially convex form with the width a little narrower on the up side. The thickness of the high-speed SD memory card 320 is thicker than that of the normal SD memory card 500.

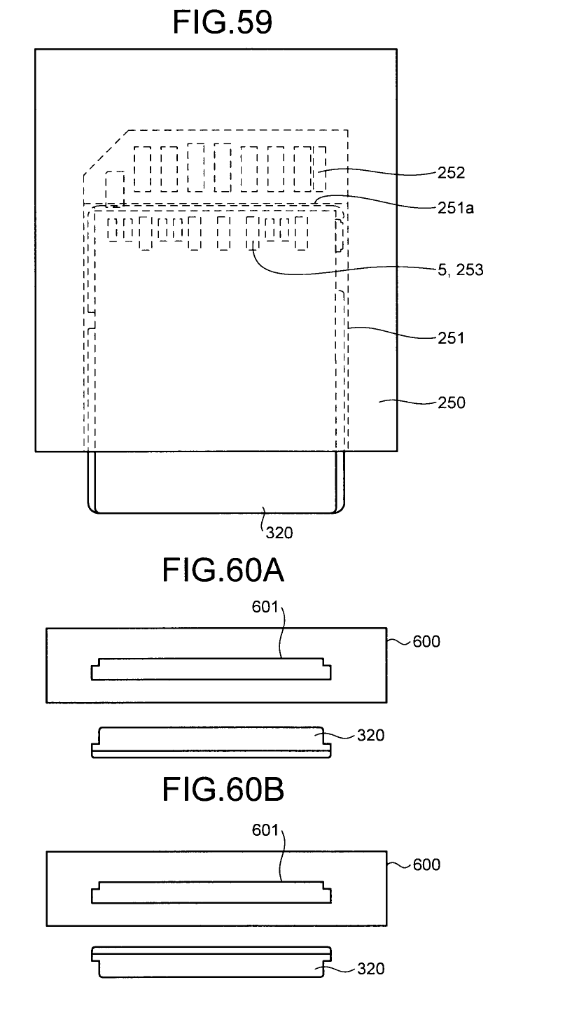

The high-speed SD memory card 320 can be inserted into the high-speed mode compatible connector 250 like in the sixth embodiment to read/write data. It is assumed, however, that the high-speed mode terminals 253 are arranged at a position corresponding to the high-speed mode pins 5 of the high-speed SD memory card 320. FIG. 59 is a diagram showing the state in which the high-speed SD memory card 320 is inserted into the card insertion hole 251 of the high-speed mode compatible connector 250. The high-speed SD memory card 320 inserted into the card insertion hole 251 interferes with the step 251a to restrict further insertion thereof at some midpoint of the card insertion hole 251. The high-speed mode pins 5 arranged at the tip in the insertion direction of the high-speed SD memory card 320 come into contact with the high-speed mode terminals 253 at the position where the further insertion is restricted due to interference with the step 251a. The position where the write protect switch 8 is arranged when the high-speed SD memory card 320 is inserted into the card insertion hole 251 while write enabled and the position where the write protect switch 8 is arranged when the hybrid SD memory card 150 is inserted into the card insertion hole 251 while write enabled are the same. Thus, the high-speed mode compatible connector 250 can perform a write-protect operation of data without distinguishing the hybrid SD memory card 150 and the high-speed SD memory card 320. Thus, the high-speed SD memory card 320 can be used in the high-speed mode compatible connector 250 compatible with the normal mode and the high-speed mode.

Moreover, the normal mode terminals 252 do not come into contact with the body of the high-speed SD memory card 320. As a result, the possibility that the outer shape of the high-speed SD memory card 320 is damaged by contact between the normal mode terminals 252 and the body of the high-speed SD memory card 320 can be reduced. Also, durability of the normal mode terminals 252 can be improved. Furthermore, when the high-speed SD memory card 320 is inserted into the card insertion hole 251 from the tip side, friction of the normal mode terminals 252 can be avoided. As a result, when the high-speed SD memory card 320 is inserted into the card insertion hole 251 from the tip side, the high-speed SD memory card 320 can be inserted easily.

FIGS. 60A and 60B are diagrams showing the relationship between the opening shape of the card insertion hole 601 of the normal connector 600 and the sectional shape of the high-speed SD memory card 320. The thickness of the high-speed SD memory card 320 is thicker than that of the normal SD memory card 500 and thus will interfere with an opening edge (see FIG. 7) of the card insertion hole 601 of the normal connector 600 regardless of how the orientation of the high-speed SD memory card 320 is changed, front and rear, up and down. That is, the high-speed SD memory card 320 cannot be inserted into the card insertion hole 601 of the normal connector 600 regardless of how the high-speed SD memory card 320 is oriented.

The opening shape of the card insertion hole of a connector (high-speed connector) dedicated to a high-speed SD memory card is the same as that of the card insertion hole 251 of the high-speed mode compatible connector 250 shown in FIG. 34. That is, the opening shape of the card insertion hole of the high-speed connector is substantially the same as the front sight of the high-speed SD memory card 220 and has a groove corresponding to the rib 3 formed on both inner walls. Thus, the high-speed SD memory card 320 cannot be inserted into the card insertion hole 251 if the high-speed SD memory card 320 is oriented upside down. If the high-speed SD memory card 320 is oriented back-to-front, the high-speed SD memory card 320 can be inserted up to the step 251a. It is needless to say that if the high-speed SD memory card 320 is inserted into the card insertion hole 251 of the high-speed connector in correct orientation, high-speed mode terminals of the high-speed connector and the high-speed mode pins 5 of the high-speed SD memory card 320 come into contact at a predetermined depth to enable data transfer in high-speed mode.

The shape of the high-speed connector is the same as that obtained by removing a portion toward the back from a step 251a of the high-speed mode compatible connector 250 shown in FIG. 35. That is, the position of the back end of the card insertion hole of the high-speed connector is a position corresponding to the position where the step 251a of the high-speed mode compatible connector 250 is provided.

A high-speed SD memory card according to this embodiment includes terminals that cause a memory controller to read/write data from/to a memory package in high-speed mode and thus, a speedup of the data transfer rate can be realized. Moreover, the high-speed SD memory card according to this embodiment can be inserted into a high-speed mode compatible connector or high-speed connector to transfer data in high-speed mode, but cannot be inserted into a normal connector. Therefore, high-speed mode terminals of the high-speed SD memory card according to this embodiment will not erroneously come into contact with normal mode pins of a normal connector.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor memory card that includes a substrate on which a semiconductor memory and a controller that controls the semiconductor memory are mounted and a case that accommodates the substrate, and capable of reading/writing data from/to the semiconductor memory in first mode and in second mode in which the data is transferred faster than in the first mode, comprising:
a first pin group used for causing the controller to read/write the data from/to the semiconductor memory in the first mode;
a second pin group used for causing the controller to read/write the data from/to the semiconductor memory in the second mode; and
an interference portion that interferes with an opening or an inner wall portion of a card insertion hole of a connector dedicated to the first mode to prevent the semiconductor memory card from being inserted up to a normal position of the card insertion hole of the connector dedicated to the first mode, wherein
one of the first pin group and the second pin group is arranged in a tip portion thereof in an insertion direction and the other in a rearward position from the tip portion in the insertion direction, each of which arranged in a direction perpendicular to the insertion direction and aligned in two rows and adjacent to each other and
the insertion direction into the connector is identical when used in the first mode and when used in the second mode.

2. The semiconductor memory card according to claim 1, further comprising a broad portion whose width is wider than an opening width of the card insertion hole of the connector dedicated to the first mode, wherein the interference portion is the broad portion.

3. The semiconductor memory card according to claim 1, wherein the interference portion is formed by adopting a shape that interferes with an opening of the card insertion hole of the connector dedicated to the first mode as the shape in a front sight of the case.

4. The semiconductor memory card according to claim 1, wherein a connector compatible with the second mode includes a second terminal group corresponding to the second pin group at a back end of the card insertion hole and a first terminal group corresponding to the first pin group on an opening side of the card insertion hole from the second terminal group and
the semiconductor memory card includes the second pin group at a tip thereof in the insertion direction into the card insertion hole and the first pin group in the rearward position from the second pin group in the insertion direction and, when inserted into the card insertion hole of the connector compatible with the second mode, the first and the second pin groups come into contact with the first and the second terminal groups.

5. The semiconductor memory card according to claim 1, wherein a connector compatible with the second mode includes a second terminal group corresponding to the second pin group at an opening end of the card insertion hole and a first terminal group corresponding to the first pin group toward the back of the card insertion hole from the second terminal group and
the semiconductor memory card includes the first pin group at a tip thereof in the insertion direction into the card insertion hole and the second pin group in the rearward position from the first pin group in the insertion direction and, when inserted into the card insertion hole of the connector compatible with the second mode, the first and the second pin groups come into contact with the first and the second terminal groups.

6. The semiconductor memory card according to claim 1, wherein at least a ground and a pair of differential data signals are assigned to the second pin group.

7. The semiconductor memory card according to claim 6, wherein a pin in the second pin group to which the differential data signal and a differential clock signal are assigned has an area smaller than the area of a pin in the second pin group to which a power source or the ground is assigned.

8. The semiconductor memory card according to claim 6, wherein pins in the first pin group to which the power source is assigned and pins in the second pin group to which the power source is assigned are arranged adjacent to each other.

9. A semiconductor memory card that includes a substrate on which a semiconductor memory and a controller that controls the semiconductor memory are mounted and a case that accommodates the substrate, and capable of reading/writing data from/to the semiconductor memory in first mode and in second mode in which the data is transferred faster than in the first mode, and which is inserted into a card insertion hole of a connector compatible with the second mode including a first terminal group at a back end of the card insertion hole and a second terminal group on an opening side of the card insertion hole from the first terminal group, comprising:
a first pin group used for causing the controller to read/write the data from/to the semiconductor memory in the first mode and arranged at one end thereof in an insertion direction into the connector; and
a second pin group used for causing the controller to read/write the data from/to the semiconductor memory in the second mode and arranged at the other end thereof in the insertion direction into the connector, wherein
an outside shape is provided in which if inserted into the card insertion hole of the connector compatible with the second mode from one end in the insertion direction, the back end of the card insertion hole is reached and one set from a set of the first pin group and the first terminal group and the set of the second pin group and the first terminal group comes into contact and, if inserted from the other end, insertion is restricted at some midpoint of the card insertion hole so that the other set comes into contact.

10. The semiconductor memory card according to claim 9, wherein a thickness dimension on a side of the other end is smaller than the thickness dimension on the side of the one end and
if inserted into the card insertion hole of the connector compatible with the second mode from one end in the insertion direction, the back end of the card insertion hole is reached and the set of the first pin group and the first terminal group comes into contact and, if inserted from the other end, insertion is restricted at some midpoint of the card insertion hole and the other set comes into contact.

11. The semiconductor memory card according to claim 9, wherein a width dimension on a side of the other end is larger than the width dimension on the side of the one end and
if inserted into the card insertion hole of the connector compatible with the second mode from one end in the insertion direction, insertion is restricted at some midpoint of the card insertion hole and the set of the first pin group and the second terminal group comes into contact and, if inserted from the other end, the back end of the card insertion hole is reached and the other set comes into contact.

12. The semiconductor memory card according to claim 9, wherein at least a ground and a pair of differential data signals are assigned to the second pin group.

13. The semiconductor memory card according to claim 12, wherein a pin in the second pin group to which the differential data signal and a differential clock signal are assigned has an area smaller than the area of a pin in the second pin group to which a power source or the ground is assigned.

14. A semiconductor memory card that includes a substrate on which a semiconductor memory and a controller that controls the semiconductor memory are mounted and a case that accommodates the substrate, and capable of reading/writing data from/to the semiconductor memory in second mode in which the data is transferred faster than in first mode, comprising:
a pin group arranged at an end in an insertion direction into a connector by being arrayed in a direction perpendicular to the insertion direction and used for causing the controller to read/write the data from/to the semiconductor memory in the second mode; and
an interference portion that interferes with an opening of a card insertion hole of the connector dedicated to the first mode to prevent the semiconductor memory card from being inserted up to a normal position of the card insertion hole of the connector dedicated to the first mode, and interferes with an inner wall of the card insertion hole of the connector compatible with both the first and the second modes by including terminals for the first mode at a back end of the card insertion hole and terminals for the second mode on an opening side of the card insertion hole from the terminals for the first mode to prevent the semiconductor memory card from being inserted toward the back end from a position where the pin group comes into contact with the terminals for the second mode.

15. The semiconductor memory card according to claim 14, further comprising a broad portion whose width is wider than an opening width of the card insertion hole of the connector dedicated to the first mode and the width at the back end of the insertion hole of the connector compatible with both modes, wherein the interference portion is formed of the broad portion.

16. The semiconductor memory card according to claim 14, further comprising a thick portion whose height dimension is larger than an opening height of the card insertion hole of the connector dedicated to the first mode and the height at the back end of the insertion hole of the connector compatible with both modes, wherein the interference portion is formed of the thick portion.

17. The semiconductor memory card according to claim 14, wherein a differential clock signal, a power source, a ground, and at least a pair of differential data signals are assigned to the pin group.

18. The semiconductor memory card according to claim 17, wherein a pin in the pin group to which the differential data signal and the differential clock signal are assigned has an area smaller than the area of a pin in the pin group to which the power source or the ground is assigned.
